(19) United States
(12) Patent Application Publication
(10) Pub. No.: US 2006/0049048 A1
(43) Pub. Date: Mar. 9, 2006

(54) Gas sensor

(76) Inventors: Tomonori Kondo, Nagoya-shi (JP); Shoji Kitanoya, Nagoya-shi (JP); Norihiko Nadanami, Nagoya-shi (JP); Noboru Ishida, Nagoya-shi (JP); Takafumi Oshima, Nagoya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/540,561

(22) PCT Filed: Dec. 25, 2003
(86) PCT No.: PCT/JP03/16840

§ 371 Date: Jun. 24, 2005

(30) Foreign Application Priority Data
Dec. 27, 2002 (JP) 2002-380795
Dec. 2, 2003 (JP) 2003-40338

(51) Int. Cl. G01N 27/26

(52) U.S. Cl. 204/425; 204/426; 204/406

(57) ABSTRACT

A gas sensor capable of reversibly and continuously measuring the concentration of a catalyst poison gas such as CO without specially needing recovering means such as a heater, and measuring the catalyst poison gas concentration without being affected by H₂O concentration. The electrical circuit (15) of the gas sensor has an AC power supply (19) for applying an AC voltage between both electrodes (3), (5), an AC voltmeter (21) for measuring an AC voltage (AC effective voltage V) between the both electrodes (3), (5), and an AC ammeter (23) for measuring a current (AC effective current I) running between the both electrodes (3), (5). An impedance is determined from the AC effective voltage V and the AC effective current I generated when the AC voltage is applied to the both electrodes (3), (5). Since this impedance corresponds to the catalyst poison gas concentration, the catalyst poison gas concentration can be determined from the impedance by using a map showing the relation between the impedance and the catalyst poison gas concentration.

### TECHNICAL FIELD

The present invention relates to a gas sensor suitable for measurement, in a fuel cell, of concentration of a catalyst poison gas, such as CO or sulfur-containing substance, contained in fuel gas, particularly, concentration of CO.

### BACKGROUND ART

With global-scale environment deterioration being perceived as a problem, in recent years, there have been actively performed studies on fuel cells, which are highly efficient, clean power sources. Among them, a polymer electrolyte fuel cell (PEFC) is a promising fuel cell, because it has advantages of low operation temperature and high output density.

A reformed gas of gasoline or natural gas shows promise as a fuel gas to be used in a PEFC. However, since CO is generated in the course of reformation reaction in accordance with conditions such as temperature and pressure, CO is present in a reformed gas. Further, sulfur-containing substances contained in the crude material may remain in a reformed gas.

Catalyst poisons such as CO and sulfur-containing substances poison Pt or the like, which is a fuel electrode catalyst of a fuel cell. Therefore, demand exists for a gas sensor capable of directly detecting the concentrations of CO and sulfur-containing substances contained in a reformed gas. In particular, the necessity of a CO sensor is high, and such a CO sensor is required to be capable of performing measurement in a hydrogen-rich atmosphere.

In view of the above, conventionally, there has been proposed a carbon monoxide sensor whose detection portion is disposed in a gas to be measured (hereinafter referred to as “analyte gas”) and which obtains CO concentration from the gradient of a change in current which flows upon application of a predetermined voltage between two electrodes (see Patent Document 1).

Further, there has also been proposed a CO gas sensor which obtains CO concentration from a CO-concentration-attributable change in response current at the time the applied voltage is changed by a pulse method (see Patent Document 2).

[Patent Document 1] Japanese Patent Application Laid-Open (kokai) No. 2001-099809 (page 2, FIG. 1)

[Patent Document 2] Japanese Patent Application Laid-Open (kokai) No. 2001-041926 (page 3, FIG. 2)

However, in the technique of Patent Document 1, since CO concentration is obtained from the gradient of a change in current which flows between two electrodes, a change in current attributable to CO; i.e., a change in the electrode catalyst attributable to CO poisoning, is irreversible. As a measure against this problem, the carbon monoxide sensor has recovery means which uses a heater. However, the sensor has a problem of having a complicated structure.

Moreover, in the carbon monoxide sensor, since the current flowing between the two electrodes changes depending on the resistance between the electrodes, the gradient of a change in current, which is the sensor output, changes with H₂O concentration. Therefore, when the H₂O concentration within a measurement atmosphere changes because of, for example, a change in operating conditions, the sensor output is influenced by the H₂O concentration, so that the sensor encounters difficulty in accurate measurement of CO concentration.

Meanwhile, in the technique of Patent Document 2, CO concentration is measured through repeated and alternating application of a CO adsorption potential and a CO oxidization potential. However, since CO concentration cannot be measured during periods in which the CO oxidization potential is applied to the sensor, the sensor has a problem in that the sensor cannot perform continuous measurement of CO concentration.

Moreover, as in the case of the technique of Patent Document 1, according to this technique, the current flowing between the two electrodes changes depending on the resistance between the electrodes;

therefore, the sensor has characteristics such that when the H₂O concentration of an analyte gas changes, the gradient of a change in current, which is the sensor output, also changes. Therefore, when the H₂O concentration of the analyte gas changes because of, for example, a change in operating conditions, the sensor output is influenced by the H₂O concentration, so that the sensor encounters difficulty in accurate measurement of CO concentration.

Furthermore, according this technique, a CO-concentration-attributable change in hydrogen oxidation reaction at catalyst of an anode electrode is measured from a change in DC current flowing through solid electrolyte film, and the CO concentration is obtained on the basis of results of this measurement. Since H₂O concentration in the vicinity of the catalyst of the anode electrode decreases as a result of the DC current flowing through the solid electrolyte film, desorption of CO becomes less likely to occur, whereby responsiveness is lowered.

An object of the present invention is to provide a gas sensor which enables reversible, continuous measurement of concentration of a catalyst poison gas such as CO, without requiring recovery means such as a heater. Another object of the present invention is to provide a gas sensor which can measure concentration of a catalyst poison gas without being influenced by H₂O concentration. Still another object of the present invention is to provide a gas sensor which has good responsiveness.

### DISCLOSURE OF THE INVENTION

(1) The invention of claim 1, which solves the above-described problems, is characterized by comprising a proton conductive layer which conducts protons (H⁺); and first and second electrodes provided in contact with the proton conductive layer, each of the electrodes including electro-chemically active catalyst and being in contact with an atmosphere of an analyte gas, wherein an AC voltage is applied between the first and second electrodes so as to measure an impedance between the first and second electrodes, and a concentration of a catalyst poison gas (concentration of a gas which poisons the catalysts) contained in the analyte gas is obtained on the basis of the impedance.

In the present invention, a change in hydrogen oxidation reaction at the catalysts with the concentration of a catalyst poison gas is measured from the impedance between the first and second electrodes, which is obtained through application of an AC voltage between the first and second electrodes, and the concentration of the catalyst poison gas such as CO is obtained on the basis of the measured impedance. By virtue of this configuration, the concentration of the catalyst poison gas can be measured reversibly and continuously with high accuracy and good responsiveness.

That is, in a conventional gas sensor which uses a solid polymer electrolyte (constituting a proton conductive layer) and which obtains CO concentration from only DC current, since DC current is caused to flow, H₂O is always pumped together with H₂, and the H₂O concentration in the vicinity of the catalyst of the anode electrode becomes very low. Further, for example, CO having adsorbed onto the catalyst reacts with H₂O so that desorption and adsorption reach an equilibrium state. Therefore, when H₂O decreases, desorption of CO does not occur immediately even when CO contained in an analyte gas is depleted. That is, when CO concentration, which can be obtained on the basis of a CO-concentration-attributable change in hydrogen oxidation reaction at the catalysts, is measured by use of DC current, the H₂O concentration in the vicinity of the catalyst of the anode electrode decreases, so that desorption and adsorption do not reach an equilibrium state, and thus, responsiveness deteriorates.

In contrast, when measurement is performed by use of alternating current as in the present invention, voltages of alternating polarities are periodically applied to the electrodes. In this case, since H₂O is always present in the vicinity of the catalyst, desorption and adsorption of a catalyst poison gas are always in an equilibrium state, and desorption of, for example, CO occurs through reaction with H₂O. Therefore, responsiveness is not deteriorated.

Poisoning by a catalyst poison gas such as CO occurs because the introduced catalyst poison gas is not desorbed after having adsorbed onto the catalyst. Therefore, through establishment of a condition in which a catalyst poison gas can always react as in the present invention, occurrence of irreversible poisoning can be avoided. Therefore, concentration of a catalyst poison gas can be reversibly and continuously measured without use of recovery means such as a heater. Notably, example waveforms of AC voltage include sinusoidal waveform, triangular waveform, and square waveform.

(2) The invention of claim 2 is characterized by comprising a proton conductive layer which conducts protons; a first electrode provided in contact with the proton conductive layer, the first electrode including electro-chemically active catalyst and being shielded from an atmosphere of an analyte gas; and a second electrode provided in contact with the proton conductive layer, the second electrode including electro-chemically active catalyst and being in contact with the analyte-gas atmosphere, wherein an AC voltage is applied between the first and second electrodes so as to measure an impedance between the first and second electrodes, and a concentration of a catalyst poison gas contained in the analyte gas is obtained on the basis of the impedance.

In a gas sensor, such as the gas sensor of the present invention, which utilizes adsorption of a catalyst poison gas onto catalyst and desorption of the catalyst poison gas therefrom, when the catalyst contents of the electrodes are high, the number of sites at which desorption and adsorption of the catalyst poison gas occur is large. Therefore, a long time is needed to create a saturated, equilibrium state associated with desorption and adsorption of the catalyst poison gas, and responsiveness deteriorates. Further, in the case of a gas sensor in which both the electrodes are exposed to an analyte gas, responsiveness depends on the electrode whose catalyst content is high, of the two electrodes. Therefore, a conceivable measure for further improving the responsiveness is sufficiently decreasing the catalyst contents of both the electrodes. However, when the catalyst carrying quantities of the electrodes are reduced, the impedance between the electrodes increases, so that an SN ratio, which is the ratio between sensitivity and zero point, deteriorates.

In view of the above, in the present invention, one electrode (first electrode) is shielded from an atmosphere of an analyte gas so as to prevent exposure of the electrode to a catalyst poison gas such as CO. Thus, the catalyst content of the first electrode, which is shielded from the analyte gas atmosphere, can be increased, so that deterioration in the SN ratio does not occur. Further, through reduction of the catalyst content of the second electrode, which is in contact with the analyte gas atmosphere, responsiveness can be improved.

Moreover, a change in hydrogen oxidation reaction at the catalyst of the second electrode, which is in contact with the analyte gas atmosphere, the change occurring with concentration of a catalyst poison gas, is measured from the impedance between the first and second electrodes, which is obtained through application of an AC voltage between the first and second electrodes, and the concentration of the catalyst poison gas such as CO is obtained on the basis of the measured impedance. In this case, since H₂O is always present in the vicinity of the catalyst of the second electrode, desorption of, for example, CO occurs through reaction with H₂O, so that deterioration in the responsiveness does not occur.

Accordingly, the present invention can provide a gas sensor which is excellent in terms of responsiveness and which suppresses lowering of the SN ratio.

(3) The invention of claim 3 is characterized in that the impedance between the first and second electrodes is measured in a state in which a DC voltage is applied between the first and second electrodes such that the first electrode is higher in electrical potential than the second electrode.

In the present invention, in a state in which the first electrode is shielded from the analyte gas atmosphere, the DC voltage is applied between the first and second electrodes such that the first electrode is higher in electrical potential than the second electrode. Therefore, H₂O molecules accompanied by protons are biased toward the cathode electrode (second electrode), and thus the H₂O concentration in the vicinity of the catalyst of the cathode electrode becomes high. Since many H₂O molecules are always present in the vicinity of the catalyst of the second electrode, which serves as a cathode electrode, when CO contained in an analyte gas is depleted, CO having adsorbed onto the catalyst can desorb immediately, so that responsiveness is improved.

(4) The invention of claim 3 is characterized in that the DC voltage is equal to or lower than 1200 mV.

The present invention shows a preferable range of the DC voltage. When the DC voltage is set to a level higher than 1200 mV, the hydrogen concentration on the first electrode becomes excessively low, so that corrosion of carbon and catalyst used in the electrodes occurs. Therefore, the impedance becomes unstable, and responsiveness deteriorates. Further, durability of the gas sensor deteriorates. Therefore, the above-described range is preferred.

(5) The invention of claim 5 is characterized by comprising a proton conductive layer which conducts protons; a diffusion-rate determining portion for determining the rate of diffusion of an analyte gas; a measurement chamber communicating with an atmosphere of the analyte gas via the diffusion-rate determining portion; a first electrode accommodated in the measurement chamber, the first electrode being in contact with the proton conductive layer and including electro-chemically active catalyst; and a second electrode provided outside the measurement chamber, the second electrode being in contact with the proton conductive layer and including electro-chemically active catalyst, wherein a DC voltage is applied between the first and second electrodes such that the first electrode is higher in electrical potential than the second electrode, to thereby pump hydrogen or protons, an AC voltage is applied between the first and second electrodes so as to measure an impedance between the first and second electrodes, and a concentration of a catalyst poison gas contained in the analyte gas is obtained on the basis of the impedance.

In the present invention, the concentration of the catalyst poison gas can be detected by measuring the impedance while pumping hydrogen or protons. That is, in the present invention, a diffusion-rate determining portion is provided, and a DC voltage is applied between the first and second electrodes such that the first electrode is higher in electrical potential than the second electrode, to thereby pump hydrogen or protons, whereby the hydrogen concentration in the measurement chamber is lowered. Therefore, in the case where the catalyst poison gas is CO, at the anode electrode side (first electrode side), a shift reaction of CO caused by H₂O, which is shown in the formula (A) below, is accelerated, so that CO can react. That is, when the DC voltage between the first and second electrodes is set to a level sufficient for causing CO to react, CO can consistently react in accordance with the formula (A), whereby the catalyst of the anode electrode (first electrode) is prevented from being influenced by CO poisoning.

Through application of an AC voltage between the first and second electrodes, a change in hydrogen oxidation reaction at the catalyst of the cathode electrode (second electrode), the change occurring with concentration of a catalyst poison gas, is measured from the impedance between the first and second electrodes. According, the concentration of the catalyst poison gas can be measured, without being influenced by poisoning of the electrode by the catalyst poison gas. Moreover, since a DC voltage is applied to the proton conductive layer, H₂O can be pumped together with hydrogen so as to bias H₂O toward the second electrode (cathode electrode). Therefore, the catalyst poison gas and H₂O can always react on the catalyst of the second electrode, whereby responsiveness is improved.
CO+H₂O→CO₂+H₂ (A)

(6) The invention of claim 6 is characterized by comprising a proton conductive layer which conducts protons; a diffusion-rate determining portion for determining the rate of diffusion of an analyte gas; a measurement chamber communicating with an atmosphere of the analyte gas via the diffusion-rate determining portion; a first electrode accommodated in the measurement chamber, the first electrode being in contact with the proton conductive layer and including electro-chemically active catalyst; and a second electrode and a reference electrode provided outside the measurement chamber, the second and reference electrodes being in contact with the proton conductive layer and including electro-chemically active catalyst, wherein, in a first operation step, a DC voltage is applied between the first and second electrodes such that the first electrode is higher in electrical potential than the second electrode and such that a predetermined potential difference is produced between the first electrode and the reference electrode; and in a second operation step, a DC voltage is applied between the first and second electrodes so as to pump hydrogen or protons, and an AC voltage is applied between the first and second electrodes so as to measure an impedance between the first and second electrodes; and a concentration of a catalyst poison gas contained in the analyte gas is obtained on the basis of the impedance obtained in the second operation step.

In the present invention, operation is performed in two steps; i.e., a step for applying a DC voltage between the first and second electrodes such that a predetermined potential difference is produced between the first electrode and the reference electrode, and a step for applying an AC voltage between the first and second electrodes so as to measure an impedance between the first and second electrodes. Accordingly, the present invention can provide effects similar to those attained by the invention of claim 5. Further, since impedance measurement can be performed in a state in which the hydrogen concentration of the measurement chamber has become constant, even when the hydrogen concentration changes, the concentration of the catalyst poison gas can be accurately measured.

(7) The invention of claim 7 is characterized in that the second electrode serves as the reference electrode, and the second electrode and the reference electrode are integrated into a single member.

In the present invention, since the second electrode and the reference electrode are integrated into a single member, the sensor structure can be simplified.

(8) The invention of claim 8 is characterized in that the potential difference between the first electrode and the reference electrode is equal to or greater than a potential for oxidation of the catalyst poison gas.

When the potential difference between the first electrode and the reference electrode is greater than a potential for oxidation of the catalyst poison gas as in the present invention, the voltage between the first and second electrodes can be made equal to or higher than a voltage at which the catalyst poison gas such as CO is oxidized. Therefore, for example, CO becomes possible to react on the catalyst of the first electrode in accordance with the above-described formula (A), whereby occurrence of irreversible poisoning by the catalyst poison gas is prevented.

(9) The invention of claim 9 is characterized in that the potential difference between the first electrode and the reference electrode is equal to or higher than 250 mV.

In the present invention, since the potential difference is equal to or higher than 250 mV, the voltage between the first and second electrodes can be made equal to or higher than a voltage at which the catalyst poison gas is oxidized. Therefore, the catalyst poison gas reacts on the catalyst of the first electrode, whereby occurrence of irreversible poisoning by the catalyst poison gas can be prevented.

In particular, the potential difference between the first electrode and the reference electrode is preferably set to 400 mV or higher. That is, when the potential difference between the first electrode and the reference electrode is set to 400 mV or higher, all the catalyst poison gas such as CO can be caused to react, whereby occurrence of irreversible poisoning by CO, etc. can be prevented.

Notably, the upper limit potential is preferably set to a potential not higher than the dissociation potential of water (e.g., not higher than 1000 mV) in order to prevent generation of error at the time of measurement.

(10) The invention of claim 10 is characterized in that the AC voltage is applied between the first and second electrodes so as to measure the impedance in a state in which a DC voltage is applied between the first and second electrodes.

The present invention exemplifies a type of voltage (power source) applied between the first and second electrodes. That is, when an AC voltage is applied between the first and second electrodes so as to measure the impedance in a state in which a DC voltage is applied between the first and second electrodes, a reaction as shown in the above-described formula (A) always occurs on the catalyst of the first electrode (anode electrode), so that the concentration of the catalyst poison gas can be obtained without being influenced by poisoning by the catalyst poison gas.

(11) The invention of claim 11 is characterized in that the DC voltage applied between the first electrode and the second electrode is equal to or higher than a voltage for oxidation of the catalyst poison gas.

When the DC voltage applied between the first electrode and the second electrode is set equal to or higher than the voltage for oxidation of the catalyst poison gas as in the present invention, the catalyst poison gas becomes possible to react on the catalyst of the first electrode, whereby occurrence of irreversible poisoning by the catalyst poison gas is prevented.

(12) The invention of claim 12 is characterized in that the DC voltage applied between the first electrode and the second electrode is equal to or higher than 400 mV.

In the present invention, since the DC voltage applied between the first electrode and the second electrode is equal to or higher than 400 mV, the voltage between the first and second electrodes becomes equal to or higher than a voltage at which the catalyst poison gas is oxidized. Therefore, the catalyst poison gas reacts on the catalyst of the first electrode, whereby occurrence of irreversible poisoning by the catalyst poison gas is prevented.

In particular, when a DC voltage of 550 mV or higher is applied between the first electrode and the second electrode, pumping of hydrogen or protons is accelerated, whereby the hydrogen concentration in the measurement chamber can be lowered to a sufficient degree. Therefore, all the catalyst poison gas can be caused to react, whereby the concentration of the catalyst poison gas (e.g., CO gas) can be accurately measured without being influenced by poisoning by CO, etc.

Notably, the upper limit voltage is preferably set to a voltage not higher than the dissociation voltage of water (e.g., not higher than 1200 mV) in order to prevent generation of error at the time of measurement.

(13) The invention of claim 13 is characterized in that the lower limit value of the AC voltage which is applied between the first electrode and the second electrode in a state in which the DC voltage is applied between the first electrode and the second electrode is equal to or higher than a voltage for oxidation of the catalyst poison gas.

According to the present invention, the lower limit value of the applied voltage is made equal to or higher than the oxidation voltage of the catalyst poison gas. Therefore, the catalyst poison gas always reacts on the catalyst of the first electrode, the concentration of the catalyst poison gas (e.g., CO gas) can be accurately measured without being influenced by poisoning by the catalyst poison gas.

(14) The invention of claim 14 is characterized in that the lower limit value of the AC voltage is 400 mV or higher.

In the present invention, since the lower limit value of the AC voltage is set to 400 mV or higher, the voltage between the first and second electrodes becomes equal to or higher than the oxidation voltage of the catalyst poison gas, whereby occurrence of poisoning by CO, etc. can be prevented. Notably, the upper limit voltage of the lower limit value of the AC voltage is preferably set to a voltage not higher than the dissociation voltage of water (e.g., not higher than 1200 mV) in order to prevent generation of error at the time of measurement.

(15) The invention of claim 15 is characterized in that a current which flows upon application of voltage between the first and second electrodes is a limiting current.

In the present invention, the hydrogen concentration on the first electrode is further lowered through pumping of hydrogen to a degree corresponding to the limiting current. Therefore, the reaction of the above-described formula (A) can be caused to occur in a more stable manner.

In the present invention, an upper limit current to which current reaches as a result of application of increasing voltage is referred to as “limiting current.” In the present invention, since AC current is applied between the electrodes, the average of changing current over a single period is referred to as “limiting current.”

(16) The invention of claim 16 is characterized in that a hydrogen concentration of the analyte gas is obtained from the limiting current.

Since the above-mentioned limiting current changes with the hydrogen concentration, the hydrogen concentration can be measured from the limiting current. That is, a voltage is applied between the first and second electrodes such that the first electrode is higher in electrical potential than the second electrode, hydrogen is dissociated to protons on the first electrode, the protons are pumped toward the second electrode via the proton conductive layer, and the protons becomes hydrogen, which is diffused to the analyte gas atmosphere. At that time, the current flowing between the first and second electrodes (limiting current (the average of changing current over a single period)) is proportional to the hydrogen concentration. Therefore, the hydrogen concentration can be measured through measurement of the current.

(17) The invention of claim 17 is characterized in that the catalyst contained in the first electrode is a catalyst capable of adsorbing the catalyst poison gas contained in the analyte gas and generating hydrogen or protons through decomposition, dissociation, or reaction with a hydrogen-containing substance.

The present invention exemplifies the catalyst. That is, when the catalyst as mentioned above is used, the catalyst poison gas such as CO can be caused to react in accordance with, for example, the above-described formula (A), whereby occurrence of irreversible poisoning by CO, etc. can be prevented.

Platinum and/or gold can be used as the catalyst.

High sensor sensitivity can be obtained by use of platinum or gold. In particular, use of an alloy or mixture of platinum and gold is preferred, because the sensor sensitivity becomes higher.

(18) The invention of claim 18 is characterized in that the concentration of the catalyst poison gas contained in the analyte gas is obtained on the basis of the impedance measured through application of AC voltages of different frequencies between the first and second electrodes.

The impedance between the first and second electrodes changes depending not only on the catalyst poison gas, but also on other gases (e.g., H₂O), temperature, etc. Therefore, the impedance between the first and second electrodes is represented by the sum of impedance Z1 which changes depending on the catalyst poison gas, and impedance Z2 which is associated with other components (e.g., H₂O).

Measurable impedance changes depending on the frequency of AC voltage applied between the electrodes.

For example, when the AC voltage is of a low frequency of about 1 Hz, the total impedance Z1+Z2 can be measured. Meanwhile, the AC voltage is of a high frequency of about 5 Hz, only the impedance Z2 can be measured.

Accordingly, the impedance Z1 corresponding only to the concentration of the catalyst poison gas is obtained from the difference between the impedance Z1+Z2 measured at the low frequency and the impedance Z2 measured at the high frequency. In this manner, on the basis of the impedances measured through application of AC voltage at different frequencies, the concentration of the catalyst poison gas can be accurately obtained, while disturbances by H₂O, etc. are eliminated.

In particular, in a system of fuel cells, H₂O concentration changes depending on operating conditions, and the impedance changes accordingly. Therefore, performing correction (H₂O correction) for eliminating the above-mentioned disturbances is preferred.

More preferably, the following procedure is employed. The phase angles of the impedance Z1+Z2 measured at the low frequency and the impedance Z2 measured at the high frequency are measured so as to obtain the respective real parts and imaginary parts of Z1+Z2 and Z2. Subsequently, the difference between the real part of Z1+Z2 and the real part of Z2 and the difference between the imaginary part of Z1+Z2 and the imaginary part of Z2 are obtained. By use of the differences of the real parts and the imaginary parts, impedance components are obtained through calculation of obtaining respective root-sum-square values. Thus, the impedance Z1, which is the difference between the impedance Z1+Z2 and the impedance Z2, can be obtained more accurately.

Notably, here, an example case in which the impedance difference is obtained has been described.

However, correction may be performed through calculation using Z2, and the correction method is not limited thereto.

(19) The invention of claim 19 is characterized in that the impedance measured through application of AC voltages of different frequencies includes two impedances which are measured through application of an AC voltage having a switching waveform composed of alternating waveforms of two different frequencies.

In the present invention, since AC voltage having a switching waveform composed of alternating waveforms of two different frequencies is applied, two impedances can be measured simultaneously through use of a single circuit. Therefore, the apparatus can be simplified.

(20) The invention of claim 20 is characterized in that the impedance measured through application of an AC voltages of different frequencies includes two impedances which are measured through application of AC voltage having a composite waveform composed of waveforms of two different frequencies.

In the present invention, since AC voltage having a composite waveform composed of waveforms of two different frequencies is applied, as in the case of the invention of claim 20, two impedances can be measured simultaneously through use of a single circuit. Therefore, the apparatus can be simplified.

(21) The invention of claim 21 is characterized in that one of the two different frequencies falls within a range of 10000 Hz to 100 Hz, and the other frequency falls within a range of 10 Hz to 0.05 Hz.

The present invention exemplifies frequency ranges in which the above-mentioned Z2 and Z1+Z2 can be obtained. By use of impedances measured in these frequency ranges, H₂O concentration dependency can be corrected, so that the concentration of the catalyst poison gas such as CO can be accurately measured.

More preferably, one of the two different frequencies is 5 kHz, and the other frequency is 1 Hz.

(22) The invention of claim 22 is characterized in that the AC voltage applied between the first and second electrodes is 5 mV or higher.

The present invention exemplifies a range of the AC voltage in which impedance measurement is possible. Impedance measurement can be properly performed when the voltage is set to the voltage range.

The AC voltage is preferably in a range of 5 to 300 mV because the sensitivity becomes high. More preferably, the AC voltage is set to 150 mV because the sensitivity becomes the highest.

(23) The invention of claim 23 is characterized in that the catalyst used for the second electrode is a catalyst capable of adsorbing the catalyst poison gas contained in the analyte gas.

The present invention exemplifies the catalyst used for the second electrode. When the catalyst as mentioned above is used, the catalyst poison gas such as CO can be properly adsorbed, so that the impedance changes. Thus, measurement of the catalyst poison gas such as CO becomes possible.

As the catalyst, a catalyst containing at least platinum can be employed. Use of a catalyst containing platinum enables proper measurement of the catalyst poison gas such as CO.

(24) The invention of claim 24 is characterized in that the density of the catalyst used for the electrodes falls within a range of 0.1 μg/cm² to 10 mg/cm².

The present invention exemplifies the density of the catalyst used for the electrodes. In the sensor of the present invention in which the impedance is measured, its sensitivity can be changed by freely changing the catalyst quantity. Therefore, measurement of the catalyst poison gas such as CO can be performed in an arbitrary concentration range.

In particular, the density of the catalyst preferably falls within a range of 1 μg/cm² to 1 mg/cm². That is, when the catalyst quantity is excessively decreased, the zero point increases, so that the SN ratio, which is the ratio between the sensitivity and the zero point, deteriorates. Meanwhile, when the catalyst quantity is excessively increased, the sensitivity lowers, so that the SN ratio deteriorates. Accordingly, when the density of the catalyst is set to fall within this range, measurement of the catalyst poison gas such as CO can be performed without deteriorating the SN ratio.

(25) The invention of claim 25 is characterized in that the catalyst poison gas is CO or a sulfur-containing substance.

The present invention exemplifies the catalyst poison gas whose concentration can be measured by use of the gas sensor. That is, CO or a sulfur-containing substance (e.g., H₂S) can be properly measured by use of the gas sensor of the present invention.

Further, the gas sensor of the present invention can be used in an atmosphere in which at least a catalyst poison gas such as CO and hydrogen are present.

### BRIEF DESCRIPTION OF DRAWINGS

FIG. 1 is an explanatory cross sectional view showing a gas sensor of Embodiment 1;

FIG. 2 is an explanatory cross sectional view showing a gas sensor of Embodiment 2;

FIG. 3 is an explanatory cross sectional view showing a gas sensor of Embodiment 3;

FIG. 4 is an explanatory cross sectional view showing a gas sensor of Embodiment 4;

FIG. 5 is an explanatory cross sectional view showing a gas sensor of Embodiment 5;

FIG. 6 is a graph showing change in impedance with change in CO concentration as measured in Experimental Example 1;

FIG. 7 is a graph showing change in impedance with change in CO concentration as measured in Experimental Example 2;

FIG. 8 is a graph showing time-cause change in impedance ratio with change in CO concentration as measured in Experimental Example 3;

FIG. 9 is a graph showing change in impedance with change in CO concentration as measured in Experimental Example 4;

FIG. 10 is a graph showing change in impedance with change in CO concentration as measured in Experimental Example 5;

FIG. 11 is graph showing the relation between DC voltage Vp and DC current Ip as measured in Experimental Example 6;

FIG. 12 is graph showing the relation between DC voltage Vp and DC current Ip as measured in Experimental Example 6;

FIG. 13 is graph showing the relation between set voltage Vs and DC current Ip as measured in Experimental Example 7;

FIG. 14 is graph showing the relation between set voltage Vs and DC current Ip as measured in Experimental Example 8;

FIG. 15 is a graph showing change in impedance with change in CO concentration as measured in Experimental Example 8;

FIG. 16A is a block diagram for the case where different frequencies are used, and FIG. 16B shows a combined waveform thereof;

FIG. 17A is an another block diagram for the case where different frequencies are used, and FIG. 17B shows a combined waveform thereof;

FIG. 18 is a graph showing the relation between measurement frequency and sensitivity as measured in Experimental Example 9;

FIG. 19 is a graph showing the relation between measurement frequency and impedance as measured in Experimental Example 9;

FIG. 20 is a graph showing the relation between AC voltage and sensitivity as measured in Experimental Example 10; and

FIG. 21 is a graph showing the relation between CO concentration and impedance as measured in Experimental Example 11.

### BEST MODE FOR CARRYING OUT THE INVENTION

Next, examples (embodiments) of the best mode of the present invention will be described.

### Embodiment 1

The present embodiment exemplifies a gas sensor used for measurement of concentrations of carbon monoxide (CO) and hydrogen contained in a fuel gas for polymer-electrolyte-type fuel cells.

a) First, the structure of the gas sensor of Embodiment 1 will be described with reference to FIG. 1. Notably, FIG. 1 is a longitudinal cross section of the gas sensor.

As shown in FIG. 1, in the gas sensor of the present embodiment, plate-shaped first and second electrodes 3 and 5 are formed on the opposite sides of a plate-shaped proton conductive layer 1 to face each other. The first and second electrodes 3 and 5 are sandwiched between plate-shaped first and second support members 7 and 9. The first and second electrodes 3 and 5 are connected to an electric circuit 15 via lead portions 11 and 13, respectively, so as to enable measurement of the impedance between the electrodes 3 and 5. These constituent elements will be described in detail.

The proton conductive layer 1 is preferably formed of a material which operates at relatively low temperature, and for example, Nafion (trademark of DuPont), which is a fluorine-based resin, can be employed. No limitation is imposed on the thickness of the proton conductive layer 1. In the present embodiment, Nafion 117 film (trade name) is used.

A porous electrode made of carbon and carrying a catalyst such as Pt can be used as the first and second electrodes 3 and 5. Alternatively, a material obtained through mixing Pt black, Pt powder, or the like with Nafion solution may be used, and Pt foil or Pt plate may used. Further, an alloy containing a catalyst component may be used. Notably, any catalyst can be used, so long as a selected catalyst is electro-chemically active. The electro-chemically active catalyst refers to a catalyst which can electro-chemically adsorb CO and H₂ and oxidize them.

A first aperture 16 and a second aperture 17 are formed in the first support member 7 and the second support member 9, respectively, so as to expose the first and second electrodes 3 and 5 to an analyte-gas atmosphere. Each of the first aperture 16 and the second aperture 17 preferably has a shape for facilitating gas diffusion, and may be composed of a single hole or a plurality of holes. Further, a gas diffusion flow passage may be formed so as to facilitate gas diffusion.

Each of the first and second support members 7 and 9 is preferably formed of a ceramic such as alumina or an insulating material such as resin. However, the first and second support members 7 and 9 may be formed of a metal such as stainless steel, if they are electrically insulated. An operable sensor can be obtained through a simple assembly in which the two electrodes 3 and 5 are physically sandwiched between the two support members 7 and 9, and thus are brought into contact with the proton conductive layer 1. Alternatively these elements may be joined together by means of hot press.

Notably, the outer surfaces (surfaces opposite the proton conductive layer 1) of the first and second electrodes 3 and 5 are airtightly covered with the first and second support members 7 and 9, respectively, so that the outer surfaces are exposed to the analyte-gas atmosphere only through the apertures 16 and 17.

The electric circuit 15 includes an AC power supply 19 for applying AC voltage between the electrodes 3 and 5; an AC voltmeter 21 for measuring AC voltage (AC effective voltage V) which is the potential difference between the electrodes 3 and 5; and an AC ammeter 23 for measuring current (AC effective current I) which flows between the electrodes 3 and 5.

Although not illustrated, in the present embodiment, electronic components (e.g., a microcomputer) for calculating an impedance from the AC effective voltage V and the AC effective current I are used.

b) Next, the measurement principle of the gas sensor of the present embodiment will be described.

When the gas sensor is disposed in a fuel gas, a catalyst poison gas such as CO having reached the first electrode 3 and the second electrode 5 is adsorbed onto respective catalysts of the first electrode 3 and the second electrode 5. Therefore, active sites, at which H₂ on the catalysts are changed to protons, are covered with the catalyst poison gas.

The adsorption and desorption of the catalyst poison gas reach an equilibrium state in the analyte-gas atmosphere, and the number of covered active sites depends on the concentration of the catalyst poison gas. That is, since the equilibrium coverage ratio of the active sites of the catalysts changes depending on the concentration of the catalyst poison gas, the impedance (between the electrodes 3 and 5) stemming from a hydrogen oxidation reaction of “H₂→2H⁺+2e⁻” changes. Therefore, the concentration of the catalyst poison gas such as CO can be measured through detection of a change in the impedance.

Specifically, the impedance (Z) can be obtained in accordance with the following equation (B) by use of the AC effective voltage V, which is applied between the first electrode 3 and the second electrode 5 and which is measured by means of the AC voltmeter 21, and the AC effective current I, which flows between the first electrode 3 and the second electrode 5 and which is measured by means of the AC ammeter 23.
Impedance Z=V/I (B)

Since the impedance corresponds to the concentration of the catalyst poison gas, the concentration of the catalyst poison gas can be obtained from the impedance by making use of, for example, a map which defines the relation between impedance and concentration of the catalyst poison gas (e.g., CO).

c) Next, effects of the gas sensor of the present embodiment will be described.

As described above, in the gas sensor of the present embodiment having the above-described structure, an AC voltage is applied between the electrodes 3 and 5, and an impedance is obtained from an AC effective voltage V and an AC effective current I measured at that time, whereby the concentration of the catalyst poison gas can be measured from the impedance.

In the present embodiment, since the concentration of the catalyst poison gas is obtained by use of impedance generated upon application of AC voltage, rather than by use of resistance which is obtained from DC current as in the conventional techniques, the gas sensor has an advantage of excellent responsiveness.

Moreover, since poisoning occurs when the introduced catalyst poison gas such as CO is not desorbed after having been adsorbed onto the catalyst. Therefore, through establishment of a state in which the catalyst poison gas can always react as in the present invention, occurrence of irreversible poisoning can be prevented. Therefore, the gas sensor of the present embodiment enables reversible, continuous measurement of concentration of the catalyst poison gas, without requiring recovery means such as a heater.

### Embodiment 2

Next, Embodiment 2 will be described; however, descriptions of portions similar to those of the above-described Embodiment 1 will be simplified.

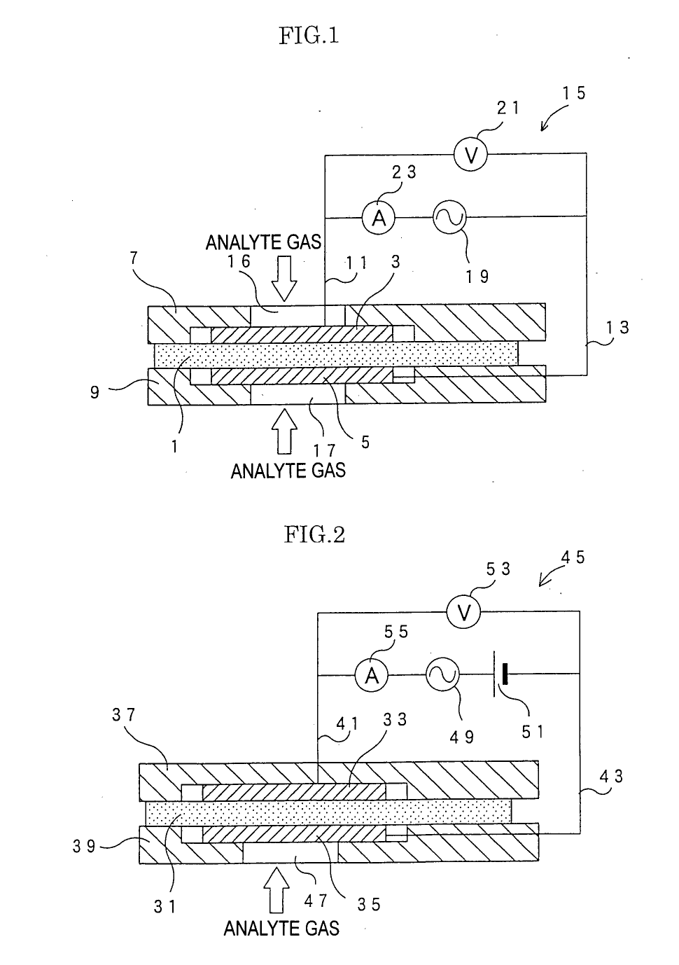

a) First, the structure of the gas sensor of Embodiment 2 will be described with reference to FIG. 2. Notably, FIG. 2 is a longitudinal cross section of the gas sensor.

As shown in FIG. 2, as in the gas sensor of Embodiment 1, the gas sensor of the present embodiment has first and second electrodes 33 and 35 which are formed on opposite sides of a proton conductive layer 31 to face each other, and the first and second electrodes 33 and 35 are sandwiched between first and second support members 37 and 39. The first and second electrodes 33 and 35 are connected to an electric circuit 45 via lead portions 41 and 43, respectively, so as to enable measurement of the impedance between the electrodes 33 and 35.

In particular, in the present embodiment, the first support member 37 and the electric circuit 45 have configurations different from those in Embodiment 1.

That is, in the present embodiment, although an aperture 47 for establishing communication between an analyte-gas atmosphere and the second electrode 35 is provided in the second support member 39, such an aperture is not provided in the first support member 37, so that the first support member 37 isolates the first electrode 33 from the analyte-gas atmosphere.

The electric circuit 45 includes an AC power supply 49 for applying AC voltage between the electrodes 33 and 35; a DC power source 51 for applying DC voltage between the electrodes 33 and 35 (such that the first electrode 33 assumes positive polarity); an AC voltmeter 53 for measuring AC voltage (AC effective voltage V) between the electrodes 33 and 35; and an AC ammeter 55 for measuring current (AC effective current I) which flows between the electrodes 33 and 35.

b) Next, the measurement principle of the gas sensor of the present embodiment will be described.

When the gas sensor is disposed in a fuel gas, a catalyst poison gas such as CO having reached the second electrode 35 is adsorbed onto the catalyst of the second electrode 35. Therefore, active sites, at which H₂ on the catalysts is changed to protons, are covered with the catalyst poison gas.

As in the case of Embodiment 1, the adsorption and desorption of the catalyst poison gas reach an equilibrium state in the analyte-gas atmosphere, and the number of covered active sites depends on the concentration of the catalyst poison gas. That is, since the equilibrium coverage ratio of the active sites of the catalysts changes depending on the concentration of the catalyst poison gas, the impedance stemming from the reaction of “H₂→2H⁺+2e⁻” changes. Therefore, the concentration of the catalyst poison gas such as CO can be measured through obtainment of a change in the impedance, which is obtained in accordance with the above-described equation (B) and by use of the AC effective voltage V and the AC effective current I.

c) Next, effects of the gas sensor of the present embodiment will be described.

The gas sensor of the present embodiment achieves advantageous effects similar to those attained by the gas sensor of Embodiment 1. Further, since the first electrode 33 is shielded from the analyte-gas atmosphere, the catalyst content of the first electrode 33 can be increased, and the catalyst content of the second electrode 35, which comes into contact with the analyte-gas atmosphere, can be decreased. Therefore, in the gas sensor of the present embodiment, responsiveness can be improved, while deterioration of an SN ratio, which is the ratio between sensitivity and the zero point, is suppressed.

Moreover, in the present embodiment, DC voltage is applied between the first and second electrodes 33 and 35 such that the first electrode 33 assumes positive polarity and the second electrode 25 assumes negative polarity. By virtue of this, a large quantity of H₂O is always present in the vicinity of the catalyst of the second electrode, which serves as a cathode electrode. Therefore, when, for example, CO contained in the analyte gas has been depleted, CO having adsorbed onto the catalyst can be desorbed immediately, so that responsiveness is improved.

### Embodiment 3

Next, Embodiment 3 will be described; however, descriptions of portions similar to those of the above-described Embodiment 2 will be simplified.

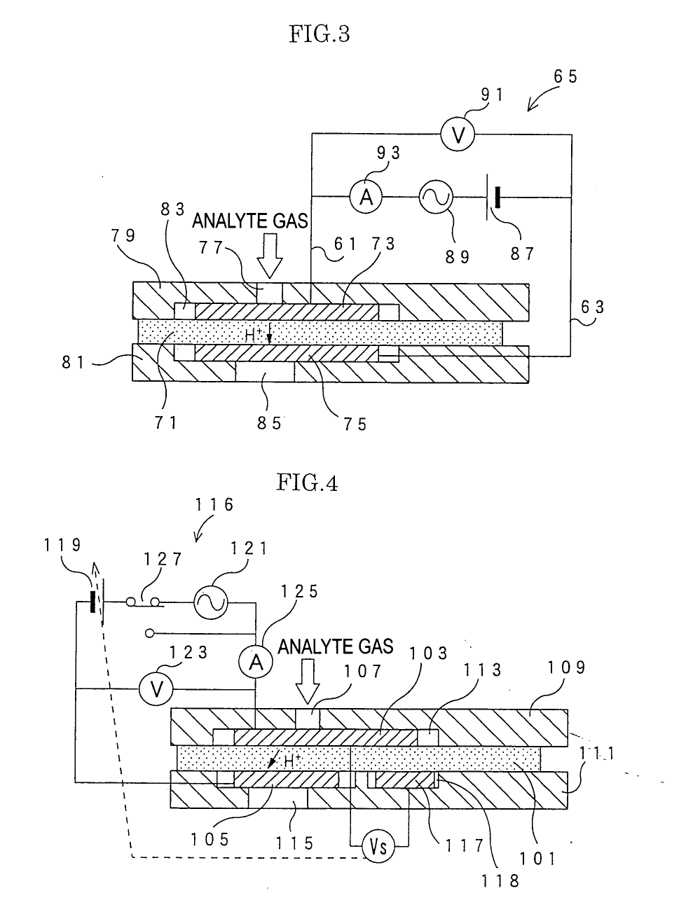

a) First, the structure of the gas sensor of Embodiment 3 will be described with reference to FIG. 3. Notably, FIG. 3 is a longitudinal cross section of the gas sensor.

As shown in FIG. 3, as in the gas sensor of Embodiment 2, the gas sensor of the present embodiment has first and second electrodes 73 and 75 which are formed on opposite sides of a proton conductive layer 71 to face each other, and the first and second electrodes 73 and 75 are sandwiched between first and second support members 79 and 81. The first and second electrodes 73 and 75 are connected to an electric circuit 65 via lead portions 61 and 63, respectively, so as to enable measurement of the impedance between the electrodes 73 and 75.

In particular, in the present embodiment, the first support member 79 has a configuration which greatly differs from that in Embodiment 2.

In the present embodiment, a diffusion-rate-determining hole 77 is provided in the first support member 79 so as to determine the rate of diffusion of an analyte gas, which is introduced from the outside of the gas sensor into a measurement chamber 83 (in which the first electrode 73 is accommodated).

Meanwhile, an aperture 85 similar to that in Embodiment 2 is provided in the second support member 81. Pumping of protons (H⁺) from the first electrode 73 to the second electrode 75 via the proton conductive layer 71 is performed.

The electric circuit 65 includes an AC power supply 89 for applying AC voltage between the electrodes 73 and 75; a DC power source 87 for applying DC voltage between the electrodes 73 and 75 (such that the first electrode 73 assumes positive polarity); an AC voltmeter 91 for measuring AC voltage (AC effective voltage V) between the electrodes 73 and 75; and an ammeter 93 for measuring current (AC effective current I and DC current) which flows between the electrodes 73 and 75.

b) Next, the measurement principle of the gas sensor of the present embodiment will be described.

When the gas sensor is disposed in a fuel gas, hydrogen and a catalyst poison gas having reached the first electrode 73 via the diffusion-rate determining hole 77 becomes protons upon application of voltage between the first electrode 73 and the second electrode 75, and the protons are pumped toward the second electrode 75 via the proton conductive layer 71.

Accordingly, the impedance associated with pumping out of protons is obtained in accordance with the above-described equation (B) and by use of the AC effective voltage V between the first electrode 73 and the second electrode 75 and the AC effective current I flowing between the first electrode 73 and the second electrode 75.

Since the impedance component associated with proton pumping changes with the concentration of the catalyst poison gas such as CO, the concentration of the catalyst poison gas can be obtained through measurement of a change in the impedance component.

Notably, protons which have been generated on the first electrode 73 upon application of voltage thereto and pumped to the second electrode 75 via the proton conductive layer 71 become hydrogen on the second electrode 75, and the thus-produced hydrogen diffuses into the analyte-gas atmosphere.

c) Next, effects of the gas sensor of the present embodiment will be described.

In the gas sensor of the present embodiment, as described above, the impedance can be obtained from the AC effective voltage V measured by means of the AC voltmeter 91 and the AC effective current I measured by means of the ammeter 93, and the concentration of the catalyst poison gas can be obtained from the impedance with high accuracy and high responsiveness.

Since the state in which CO introduced into the measurement chamber 83 can always react is established, occurrence of irreversible poisoning is prevented. This eliminates the necessity of recovery means such as a heater, and enables reversible, continuous measurement of CO.

Moreover, since the current flowing between the first electrode 73 and the second electrode 75 is the limiting current, the reaction of the above-mentioned formula (A) can be caused to occur stably. Thus, CO concentration can be measured stably and accurately.

In addition, since the limiting current flowing between the first electrode 73 and the second electrode 75 is proportional to the concentration of hydrogen within the measurement chamber 83, the concentration of hydrogen within the analyte gas can be obtained from the limiting current.

### Embodiment 4

Next, Embodiment 4 will be described; however, descriptions of portions similar to those of the above-described Embodiment 3 will be simplified.

a) First, the structure of the gas sensor of Embodiment 4 will be described with reference to FIG. 4. Notably, FIG. 4 is a longitudinal cross section of the gas sensor.

As shown in FIG. 4, as in the gas sensor of Embodiment 3, the gas sensor of the present embodiment has a proton conductive layer 101, a first electrode 103, a second electrode 105, a diffusion-rate-determining hole 107, a first support member 109, a second support member 111, a measurement chamber 113, an aperture 115, an electric circuit 116, etc.

In particular, in the present embodiment, in addition to the first electrode 103 and the second electrode 105, a reference electrode 117 is provided outside the measurement chamber 113, which accommodates the first electrode 103. That is, the reference electrode 117 is disposed in a small chamber 118 provided in the second support member 111, such that the reference electrode 117 is in contact with the proton conductive layer 101 and is separated from the second electrode 105.

The reference electrode 117 is formed so as to reduce the influence of change in concentration of hydrogen contained in the analyte gas. Preferably, the reference electrode 117 is caused to serve as a self-generation reference electrode so as to further stabilize the hydrogen concentration at the reference electrode 117. The reference electrode 117 serves as a self-generation reference electrode when a constant small current is caused to flow from the first electrode 103 or the second electrode 105 to the reference electrode 117, and a portion of hydrogen gas having flown is caused to leak to the outside via a predetermined leak resistant portion (e.g., a very small hole).

In the present embodiment, the electric circuit 116 operates as follows. A DC power source 119 applies DC voltage between the first electrode 103 and the second electrode 105. An AC power supply 121 applies AC voltage between the first electrode 103 and the second electrode 105. An AC voltmeter 123 measures AC effective voltage V between the first electrode 103 and the second electrode 105. An ammeter 125 measures AC effective current I and DC current flowing between the first electrode 103 and the second electrode 105.

Further, the electric circuit 116 includes a switching element 127 in order to selectively connect the terminal on the side of the second electrode 105 to the terminal on the side of the AC power supply 121 or the terminal on the side of the ammeter 125; i.e., in order to effect changeover between a state in which AC voltage is applied and a state in which AC voltage is not applied.

In the present embodiment, the DC voltage applied between the first electrode 103 and the second electrode 105 is adjusted such that the potential difference Vs between the first electrode 103 and the reference electrode 117 attains a constant value (e.g., 450 mV) equal to or higher than 400 mV.

b) Next, the operation of the gas sensor of the present embodiment will be described.

In the present embodiment, through changeover of the switching element 127, first and second steps are alternately performed at prescribed intervals so as to measure the concentration of CO gas.

Specifically, in the first step, a sufficiently high DC voltage is applied between the first electrode 103 and the second electrode 105 such that the limiting current flows between the first electrode 103 and the second electrode 105, whereby the potential difference between the first electrode 103 and the reference electrode 117 attains the above-mentioned constant value. In this state, current flowing between the first electrode 103 and the second electrode 105 is measured.

That is, in the present embodiment, since the DC voltage applied between the first electrode 103 and the second electrode 105 can be changed such that the potential difference between the first electrode 103 and the reference electrode 117 becomes constant, optimal DC voltage is applied between the first electrode 103 and the second electrode 105. Specifically, when the resistance between the first electrode 103 and the second electrode 105 increases because of, for example, a change in the temperature of the analyte gas, a higher voltage is applied between the first electrode 103 and the second electrode 105; and when the resistance between the first electrode 103 and the second electrode 105 decreases, a lower voltage is applied between the first electrode 103 and the second electrode 105.

Meanwhile, in the second step, while the above-described optimal DC voltage is applied between the first electrode 103 and the second electrode 105 to thereby pump hydrogen or protons, AC voltage is applied thereto so as to measure the impedance between the first electrode 103 and the second electrode 105.

Accordingly, the present embodiment achieves not only the effects of the above-described Embodiment 3, but also the following effect. Through repeated and alternating execution of the first and second steps, the impedance between the first electrode 103 and the second electrode 105 can be measured with the hydrogen concentration within the measurement chamber 117 maintained constant and without being affected by disturbances, and the concentration of the catalyst poison gas such as CO can be accurately detected on the basis of the impedance.

### Embodiment 5

Next, Embodiment 5 will be described; however, descriptions of portions similar to those of the above-described Embodiment 4 will be simplified.

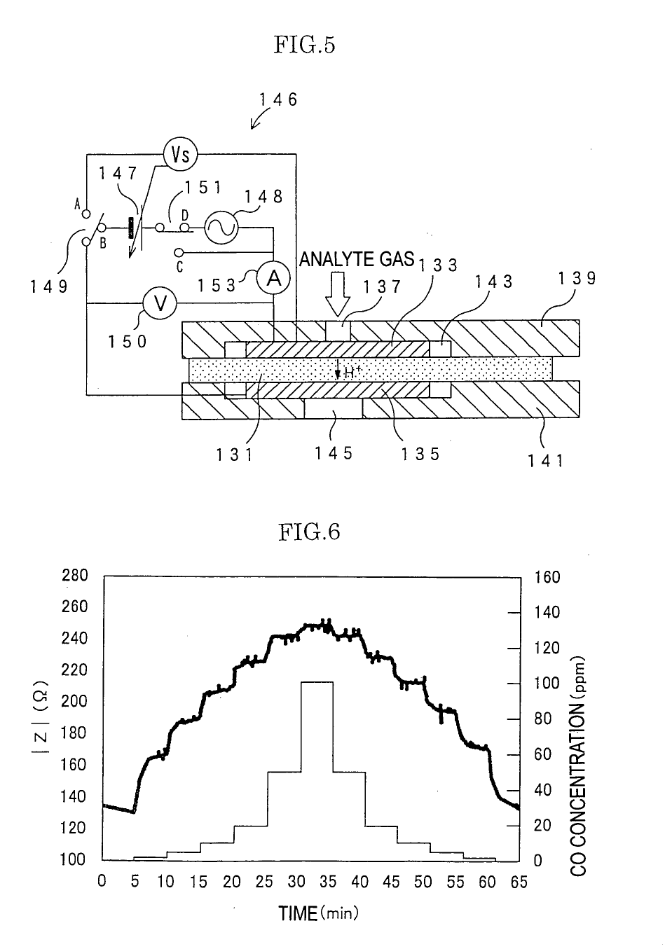

a) First, the structure of the gas sensor of Embodiment 5 will be described with reference to FIG. 5. Notably, FIG. 5 is a longitudinal cross section of the gas sensor.

As shown in FIG. 5, as in the gas sensor of Embodiment 4, the gas sensor of the present embodiment has a proton conductive layer 131, a first electrode 133, a second electrode 135, a diffusion-rate-determining hole 137, a first support member 139, a second support member 141, a measurement chamber 143, an aperture 145, an electric circuit 146, etc. In particular, the present embodiment is characterized in that the second electrode 135 has a function of a reference electrode and is integrated with a reference electrode.

In the present embodiment, the electric circuit 146 operates as follows. A DC power source 147 applies DC voltage between the first electrode 133 and the second electrode 135. An AC power supply 148 applies AC voltage between the first electrode 133 and the second electrode 135. An AC voltmeter 150 measures AC effective voltage V between the first electrode 133 and the second electrode 135. An ammeter 153 measures AC effective current I flowing between the first electrode 133 and the second electrode 135.

Further, the electric circuit 146 includes a first switching element 149 and a second switching element 151. The first switching element 149 selectively connects the common terminal on the side of the second electrode 135 to the terminal (A terminal) on the side of the first electrode 133 or the terminal (B terminal) on the side of the DC power source 147. The second switching element 151 selectively connects the common terminal on the side of the second electrode 135 (the positive side of the DC power source 147) to the terminal (C terminal) on the side of the ammeter 153 or the terminal (D terminal) on the side of the AC power supply 148.

In the present embodiment, the DC voltage applied between the first electrode 133 and the second electrode 135 serving as a reference electrode is adjusted such that the potential difference Vs between the first electrode 133 and the second electrode 135 becomes a constant value (e.g., 450 mV) equal to or higher than 400 mV.

b) Next, the operation of the gas sensor of the present embodiment will be described.

The potential difference (Vs) between the first electrode 133 and the second electrode 135 is measured in a state in which the common terminal of the first switching element 149 is connected to the A terminal.

Subsequently, the first switching element 149 is switched such that its common terminal is connected to the B terminal, and the common terminal of the second switching element 151 is connected to the C terminal. In this state, DC voltage is applied between the first electrode 133 and the second electrode 135 such that the measured potential difference between the first electrode 133 and the second electrode 135 becomes a constant value (e.g., 450 mV).

After elapse of a predetermined time, the second switching element 151 is switched such that its common terminal is connected to the D terminal so as to apply AC voltage between the first electrode 133 and the second electrode 135, while the previously-mentioned DC voltage is applied thereto. In this state, the impedance between the first electrode 133 and the second electrode 135 is measured by use of the above-mentioned impedance analyzer.

Since the impedance between the first electrode 133 and the second electrode 135 changes depending on the concentration of the catalyst poison gas within the analyte gas, the concentration of the catalyst poison gas such as CO can be detected from the impedance.

Accordingly, the present embodiment achieves not only the effects of the above-described Embodiment 4, but also an advantageous effect such that the structure of the sensor can be simplified.

Next, experimental examples performed for confirming the effects of the present invention will be described.

### EXPERIMENTAL EXAMPLE 1

First, an experimental example performed for confirming the effects of Embodiment 1 will be described.

In Experimental Example 1, CO concentration measurement was performed by use of the gas sensor of Embodiment 1 shown in FIG. 1.

Specifically, impedance measurement was performed under the conditions described below by use of an impedance analyzer (SI 1260 IMPEDANCE/GAIN-PHASE ANALYZER, PRODUCT OF SOLARTRON).

<<Measurement Conditions>>

Gas component: CO=0→2→5→10→20→50→100→50→20→10→5→2→0 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt carrying carbon catalyst (catalyst density: 15 μg/cm²)

Electrode catalyst of the second electrode: Pt carrying carbon catalyst (catalyst density: 15 μg/cm²)

21 <Impedance Analyzer>>

The following is set between the first and second electrodes.

DC voltage: 0 mV

AC voltage: 150 mV (effective value)

Measurement frequency: 1 Hz

FIG. 6 shows the results. As is apparent from FIG. 6, the sensor output (the absolute value of the impedance Z) changes with change in CO concentration, and therefore, CO concentration can be reversibly measured by use of the gas sensor of Embodiment 1, without use of recovery means such as a heater.

### EXPERIMENTAL EXAMPLE 2

In Experimental Example 2, CO concentration measurement was performed by use of the gas sensor of Embodiment 2 shown in FIG. 2.

Specifically, measurement of the impedance Z was performed under the conditions described below by use of the above-mentioned impedance analyzer.

<<Measurement Conditions>>

Gas component: CO=0→2→5→10→20→50→100→50→20→10→5→2→0 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt carrying carbon catalyst (catalyst density: 1 mg/cm²)

Electrode catalyst of the second electrode: Pt carrying carbon catalyst (catalyst density: 15 μg/cm²)

<<Impedance Analyzer>>

The following is set between the first and second electrodes.

DC voltage: 700 mV

AC voltage: 150 mV (effective value)

Measurement frequency: 1 Hz

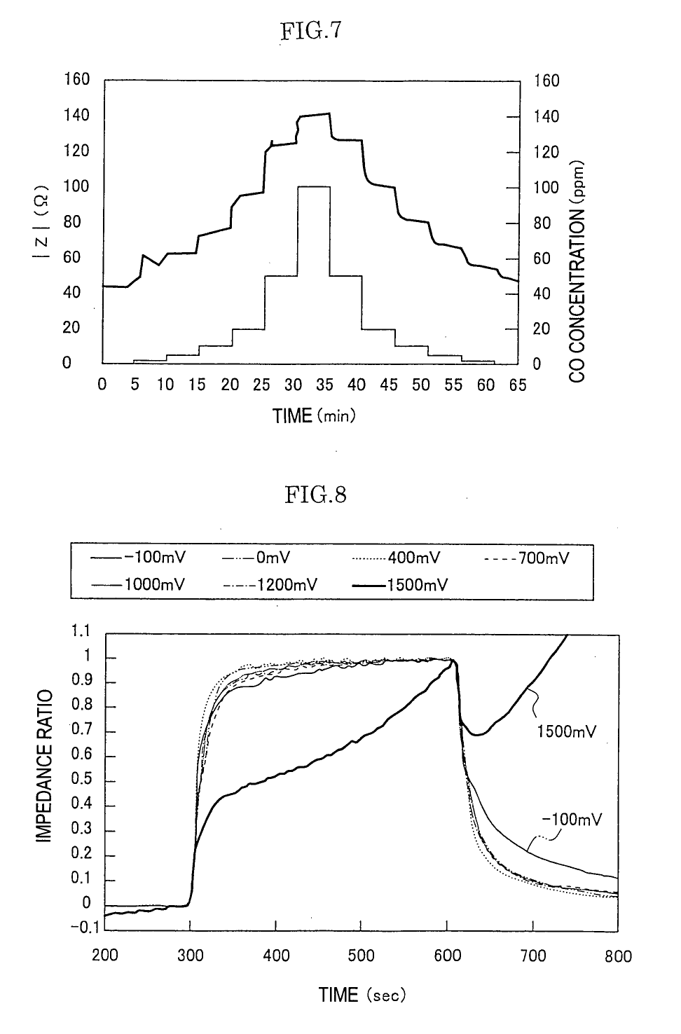

FIG. 7 shows the results. As is apparent from FIG. 7, the sensor output (the absolute value of the impedance Z) changes with change in CO concentration, and therefore, CO concentration can be reversibly measured by use of the gas sensor of Embodiment 2, without use of recovery means such as a heater.

### EXPERIMENTAL EXAMPLE 3

In Experimental Example 3, an experiment was performed to determine the responsiveness of the gas sensor of Embodiment 2 shown in FIG. 2.

Specifically, the DC current applied between the first and second electrodes was changed under the following conditions, impedance measurement was performed by use of the above-mentioned impedance analyzer, and an impedance ratio was obtained. Notably, impedance ratio refers to an impedance value normalized such that the impedance at CO=0 ppm is set to zero, and the sensitivity (a value obtained by subtracting the impedance at CO=0 ppm from the impedance at CO=100 ppm) is taken as 1.

<<Measurement Conditions>>

Gas component: CO=0→100→0 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt carrying carbon catalyst (catalyst density: 1 μg/cm²)

Electrode catalyst of the second electrode: Pt carrying carbon catalyst (catalyst density: 15 μg/cm²)

<<Impedance Analyzer>>

The following is set between the first and second electrodes.

DC voltage: 0, 400, 700, 1000, 1200 mV (examples), −100, 1500 mV (comparative examples)

AC voltage: 150 mV (effective value)

Measurement frequency: 1 Hz

FIG. 8 shows the results. In FIG. 8, the horizontal axis represents time, and the vertical axis represents impedance ratio, and FIG. 8 shows a response at the time when CO concentration was changed from 0 ppm to 100 ppm. Notably, when a DC voltage of −100 mV is applied, the first electrode becomes the negative electrode.

FIG. 8 shows that in the case of a first comparative example in which the DC voltage is −100 mV, the response characteristic deteriorates. This deterioration occurs for the following reason. When the DC voltage is -100 mV, hydrogen is pumped toward the shielded first electrode, so that the H₂O concentration in the vicinity of the catalyst of the second electrode in contact with the analyte-gas atmosphere decreases, and desorption of CO becomes less likely to occur. This reveals that it is preferred not to apply DC voltage between the first and second electrodes (0 mV) or to apply DC voltage such that the first electrode assumes positive polarity.

Further, FIG. 8 shows that in the case of a second comparative example in which the DC voltage is 1500 mV, the response characteristic greatly deteriorates. This deterioration occurs for the following reason. Since the hydrogen concentration on the first electrode becomes excessively low as a result of application of high voltage, corrosion of carbon and catalyst used in the electrodes occurs, and the impedance becomes unstable.

The above results show that a preferable range of DC voltage in which CO concentration can be measured by use of the gas sensor of Embodiment 2 with high responsiveness is 0 to 1200 mV.

### EXPERIMENTAL EXAMPLE 4

In Experimental Example 4, CO concentration measurement was performed by use of the gas sensor of Embodiment 3 shown in FIG. 3.

Specifically, measurement of the impedance Z was performed under the conditions described below by use of the above-mentioned impedance analyzer.

<<Measurement Conditions>>

Gas component: CO=1000, 5000, 10000, 15000, 20000 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt—Au carrying carbon catalyst (catalyst density: 1 mg/cm²)

Electrode catalyst of the second electrode: Pt carrying carbon catalyst (catalyst density: 1 mg/cm²)

<<Impedance Analyzer>>

The following is set between the first and second electrodes.

DC voltage: 700 mV

AC voltage: 150 mV (effective value)

Measurement frequency: 1 Hz

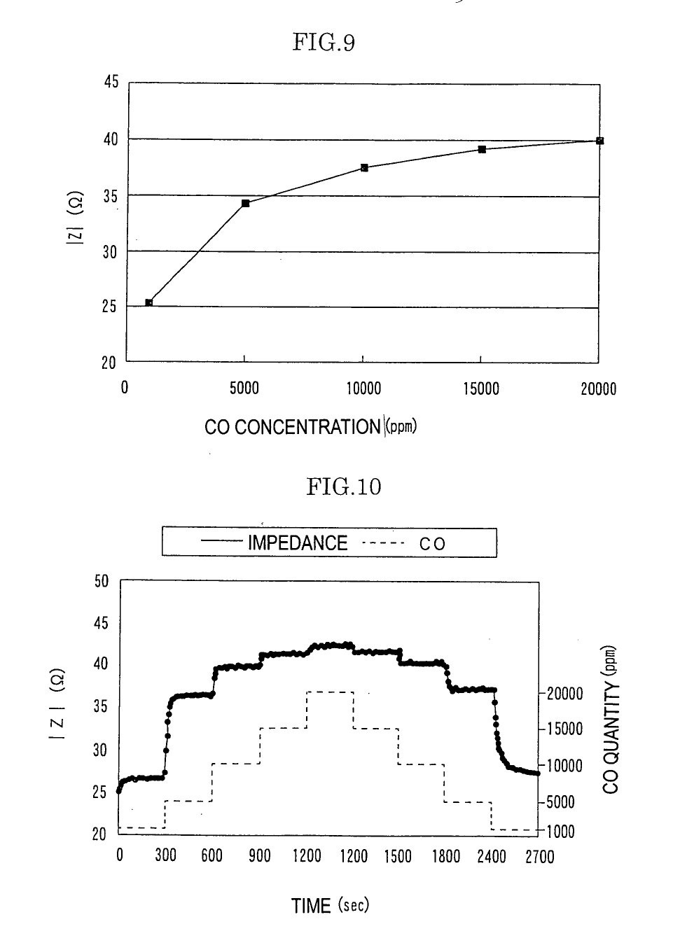

FIG. 9 shows the results. As is apparent from FIG. 9, the sensor output changes with change in CO concentration, and therefore, CO concentration can be measured by use of the gas sensor of Embodiment 3.

### EXPERIMENTAL EXAMPLE 5

In Experimental Example 5, an experiment was performed to determine the responsiveness of the gas sensor of Embodiment 3 shown in FIG. 3.

Specifically, the DC current applied between the first and second electrodes was changed under the following conditions, impedance measurement was performed by use of the above-mentioned impedance analyzer, and an impedance ratio was obtained.

<<Measurement Conditions>>

Gas component: CO=1000→5000→10000→15000→20000→15000→10000→5000→1000 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt—Au carrying carbon catalyst (catalyst density: 1 mg/cm²)

Electrode catalyst of the second electrode: Pt carrying carbon catalyst (catalyst density: 1 mg/cm²)

<<Impedance Analyzer>>

The following is set between the first and second electrodes.

DC voltage: 700 mV

AC voltage: 150 mV (effective value)

Measurement frequency: 1 Hz

Data sampling interval: 5 sec

FIG. 10 shows the results. As is understood from FIG. 10, the sensor output changes reversibly with change in CO concentration. That is, the result shows that CO concentration can be measured reversibly by use of the gas sensor of Embodiment 3, without use of recovery means such as a heater.

The electrode catalyst used for the first electrode contains Pt and Au at a weight ratio of 1:1, which are carried by carbon powder. The added gold may be subjected to an alloying process, or may be contained as a mixture.

### EXPERIMENTAL EXAMPLE 6

In Experimental Example 6, an experiment was performed to determine the range of DC voltage, in which range CO concentration can be measured by use of the gas sensor of Embodiment 3 shown in FIG. 3.

Specifically, the DC voltage (Vp) applied between the first and second electrodes was changed under the following conditions, and the current (Ip) flowing between the electrodes at that time was measured. In this experiment, AC voltage was not applied to the first and second electrodes.

<<Measurement Conditions>>

Gas component: CO=0, 20000 ppm

Remaining gas components: H₂=35%; CO₂=15%; H₂O=25%; and N₂ (balance) (volume %)

Gas temperature: 80° C.

Gas flow rate: 10 L/min

Applied Voltage Vp: 0 to 1000 mV (100 mV/min sweep application)

Electrode catalyst of the first electrode: Pt—Au carrying carbon catalyst (catalyst density: 1 mg/cm²)

Electrode catalyst of the second electrode: Pt carrying carbon catalyst (catalyst density: 1 mg/cm²)

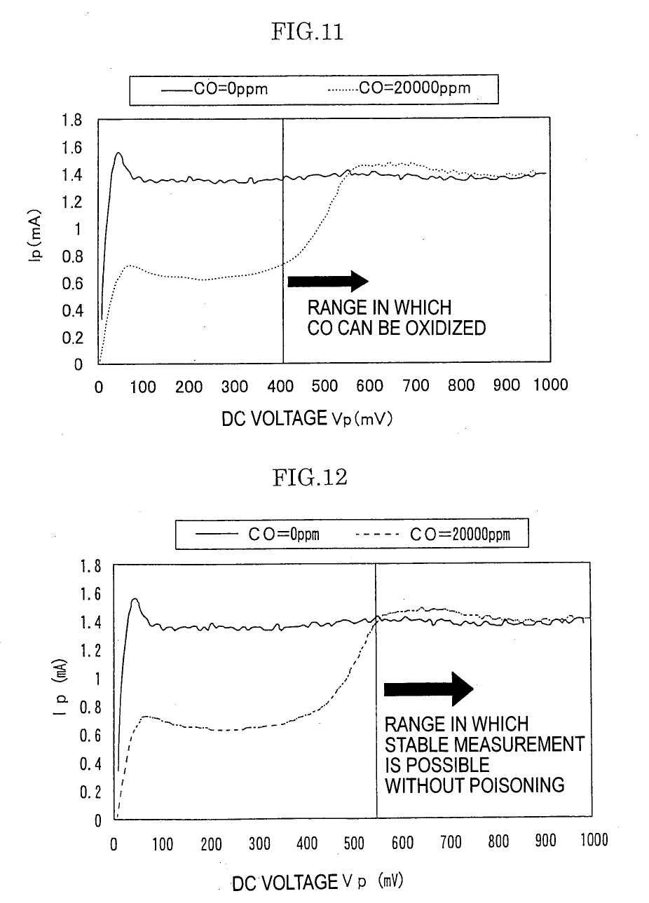

FIGS. 11 and 12 show the results. In these drawings, the horizontal axis represents applied voltage Vp, and the vertical axis represents current value Ip.

From these drawings, it is understood that in the case of CO=0 ppm, the current value (Ip) becomes constant (limiting current) when the applied voltage (Vp) reaches 100 mV. However, in the case of CO=20000 ppm, the current value is low (does not reach the limiting current), which shows that the sensor has been poisoned by CO. However, in a region in which Vp is 400 mV or higher, the current value starts to increase, and in a region in which Vp is 550 mV or higher, the current value is maintained at the limiting current even in the case where CO=20000 ppm.

Accordingly, from this experiment, it is understood that when the DC voltage is set to 400 mV or higher as shown in FIG. 11, CO starts to be oxidized in accordance with the above-described formula (A), and CO concentration can be stably measured, without being influenced by poisoning. Moreover, it is understood that when the DC voltage is set to 550 mV or higher as shown in FIG. 12, all CO can react in accordance with the above-described formula (A), and CO concentration can be stably measured, without being influenced by CO poisoning.

### EXPERIMENTAL EXAMPLE 7

In Experimental Example 7, an experiment was performed to determine the range of the potential difference between the reference electrode and the first electrode, in which range CO concentration can be stably measured by use of the gas sensor of Embodiment 4 shown in FIG. 4.

Specifically, the DC voltage (Vp) applied between the first and second electrodes was changed, while the potential difference (Vs) between the reference electrode and the first electrode was monitored; and the DC current (Ip) flowing between the first and second electrodes was measured. In this experiment, AC voltage was not applied to the first and second electrodes.

<<Measurement Conditions>>

Gas component: CO=0, 20000 ppm

Remaining gas components: H₂=35%; CO₂=15%; H₂O=25%; and N₂ (balance) (volume %)

Gas temperature: 80° C.

Gas flow rate: 10 L/min

Applied Voltage Vp: 0 to 1000 mV (100 mV/min sweep application)

Electrode catalyst of the first electrode: Pt—Au carrying carbon catalyst (catalyst density: 1 mg/cm²)

Electrode catalyst of the second electrode: Pt carrying carbon catalyst (catalyst density: 1 mg/cm²)

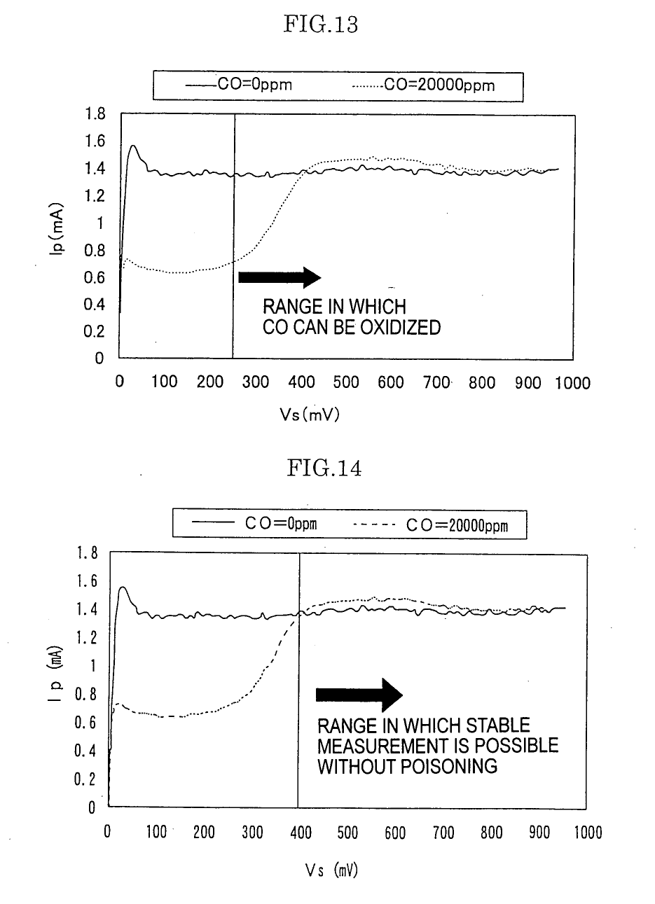

FIGS. 13 and 14 show the results. From these drawings, it is understood that in the case of CO=0 ppm, the current value (Ip) becomes constant (limiting current) when Vs reaches 100 mV. However, in the case of CO=20000 ppm, the current value is low (does not reach the limiting current), which shows that the sensor has been poisoned by CO.

However, in a region in which Vs is 250 mV or higher (the region in which CO can be oxidized; see FIG. 13), the current value starts to increase, and in a region in which Vs is 400 mV or higher (the region in which measurement can be stably performed without being influenced by poisoning; see FIG. 14), the current value is maintained at the limiting current even in the case where CO=20000 ppm.

Accordingly, from this experiment, it is understood that when the voltage Vs is set to 250 mV or higher, CO starts to be oxidized in accordance with the above-described formula (A), and CO concentration can be stably measured, without being influenced by poisoning.

Moreover, it is understood that when the voltage Vs is set to 400 mV or higher as shown in FIG. 14, all CO can react in accordance with the above-described formula (A), and CO concentration can be stably measured, without being influenced by CO poisoning.

### EXPERIMENTAL EXAMPLE 8

In Experimental Example 8, CO concentration measurement was performed by use of the gas sensor of Embodiment 3 shown in FIG. 3, and CO concentration correction was performed during the measurement.

The concentration of H₂O contained in the analyte gas changes depending on the operating conditions, and the above-described impedance (in particular, the internal impedance of the proton conductive layer) changes with the changing H₂O concentration. The correction for CO concentration measurement is performed so as to eliminate the influence of the H₂O concentration.

In this experiment, impedance measurement was performed under the following conditions. That is, impedance measurement was performed while the frequency of the applied AC voltage was set to different frequencies (1 Hz and 5 kHz in cases (1) and (2), respectively, which will be described below).

<<Measurement Conditions>>

Gas component: CO=1000, 5000, 10000, 15000, 20000 ppm

Remaining gas components: H₂=35%; CO₂=15%; H₂O=15, 20, 25, 30, 35%; and N₂ (balance) (volume %)

Gas temperature: 80° C.

Gas flow rate: 10 L/min

Electrode catalyst of the first electrode: Pt—Au carrying carbon catalyst (catalyst density: 1 mg/cm²)

Electrode catalyst of the second electrode: Pt carrying carbon catalyst (catalyst density: 1 mg/cm²)

<<(1) Impedance Analyzer>>

The following is set between the first and second electrodes.

DC voltage: 700 mV

AC voltage: 150 mV (effective value)

Measurement frequency: 1 Hz

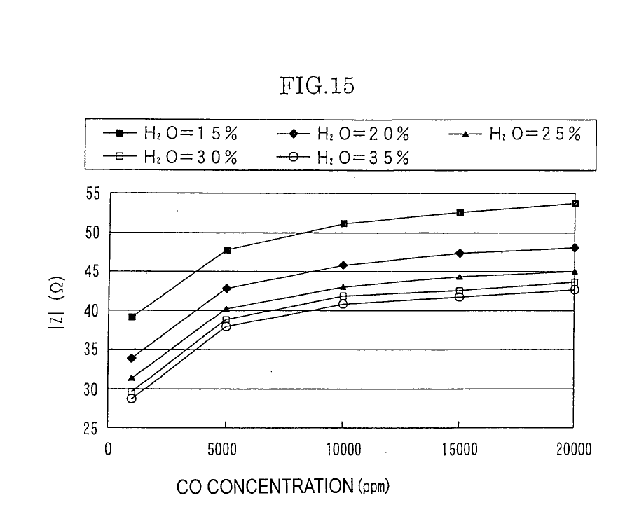

FIG. 15 shows the results. As is apparent from FIG. 15, at each H₂O concentration, the impedance (accordingly, the sensor output) changes with CO concentration, and therefore, CO concentration can be measured at each H₂O concentration.

However, when only data obtained at 1 Hz are used, CO concentration measurement is influenced by H₂O concentration, because the sensor output changes with H₂O concentration. Accordingly, as described below, the internal impedance of the proton conductive layer (the impedance between the first and second electrodes) was further measured, while the measurement frequency was changed.

<<(2) Impedance Analyzer>>

The following is set between the first and second electrodes.

DC voltage: 700 mV

AC voltage: 150 mV (effective value)

Measurement frequency: 5 kHz

The results are shown in the following Table 1. In Table 1, the difference between each pair of impedances measured at the respective frequencies is shown.

TABLE 1

| CO | H₂O | | | Difference between |
|---|---|---|---|---|
| concentra- | concentra- | Impedance | Impedance | 1 Hz impedance and |
| tion [ppm] | tion [%] | at 1 Hz | at 5 kHz | 5 kHz impedance |
| 1000 | 15 | 38.90 | 15.80 | 23.10 |
| | 20 | 33.80 | 10.80 | 23.00 |
| | 25 | 31.26 | 8.18 | 23.08 |
| | 30 | 29.73 | 6.63 | 23.10 |
| | 35 | 29.14 | 5.42 | 23.72 |
| 5000 | 15 | 47.84 | 15.81 | 32.02 |
| | 20 | 42.72 | 10.76 | 31.96 |
| | 25 | 40.11 | 8.12 | 31.99 |
| | 30 | 38.58 | 6.53 | 32.05 |
| | 35 | 37.88 | 5.34 | 32.54 |
| 10000 | 15 | 51.20 | 15.88 | 35.33 |
| | 20 | 45.73 | 10.74 | 35.00 |
| | 25 | 43.03 | 8.06 | 34.97 |
| | 30 | 41.63 | 6.47 | 35.16 |
| | 35 | 40.51 | 5.28 | 35.24 |
| 15000 | 15 | 52.66 | 15.93 | 36.73 |
| | 20 | 47.47 | 10.73 | 36.74 |
| | 25 | 44.41 | 8.03 | 36.38 |
| | 30 | 42.42 | 6.42 | 36.00 |
| | 35 | 41.85 | 5.23 | 36.62 |
| 20000 | 15 | 53.77 | 16.00 | 37.77 |
| | 20 | 48.18 | 10.73 | 37.46 |
| | 25 | 45.09 | 8.00 | 37.09 |
| | 30 | 43.57 | 6.32 | 37.25 |
| | 35 | 42.49 | 5.19 | 37.30 |

As shown in Table 1, when CO concentration measurement is performed by use of only the impedance (A_{1Hz}) between the first and second electrodes as measured at 1 Hz, the measurement is influenced by H₂O concentration. However, the difference ΔZ between the impedance (Z_{1Hz}) between the first and second electrodes as measured at 1 Hz and the internal impedance (Z_{5kHz}) of the proton conductive layer as measured at 5 kHz corresponds to CO concentration.

Accordingly, use of the impedance difference AZ enables accurate measurement of CO concentration, without any dependency on H₂O concentration.

Here, there will be described two methods a) and b) for measuring the impedance through use of alternating voltage having a waveform including components of two different frequencies.

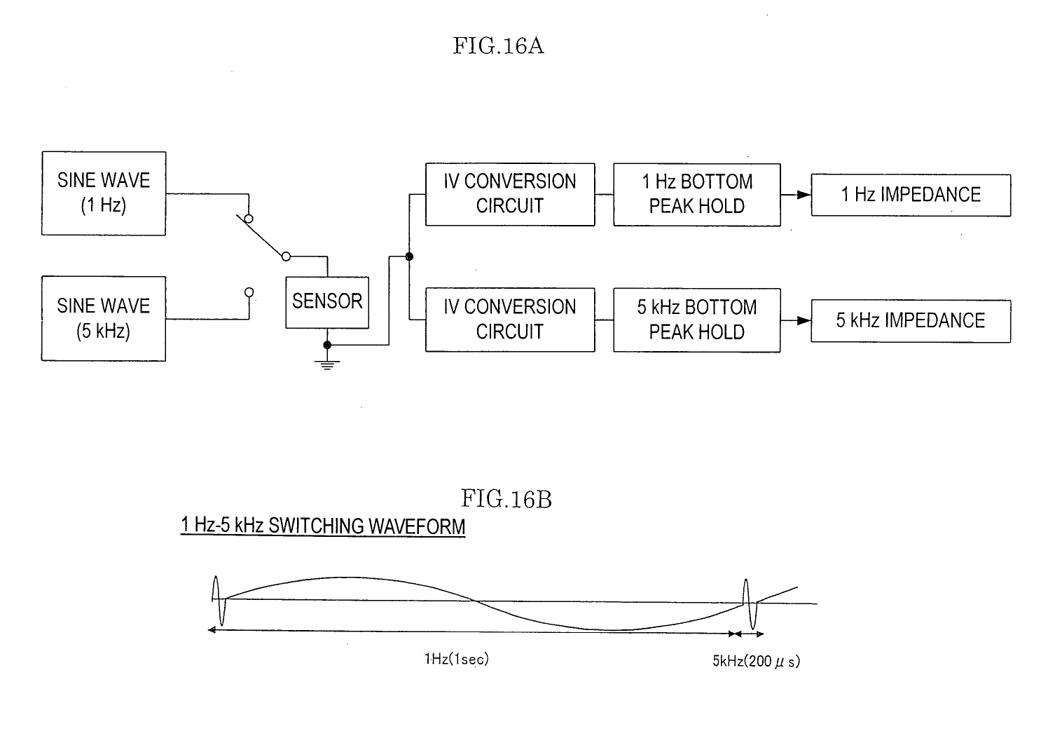

a) As shown in FIG. 16A, in an electric circuit, an AC voltage having a waveform which contains a low frequency (1 Hz) component and a high frequency (5 kHz) component (see FIG. 16B) is produced through changeover of a switch, and is applied to the sensor. The current value at the time when each of the frequency components is applied to the sensor is converted to a voltage by means of a corresponding IV conversion circuit. The bottom peak of the low frequency voltage and the bottom peak of the high frequency voltage are held, and the impedance at the low frequency and the impedance at the high frequency are calculated from these values.

A predetermined calculation is performed by use of the impedance at the low frequency and the impedance at the high frequency, whereby the above-mentioned impedance difference ΔZ is obtained. After that, a CO concentration corresponding to ΔZ is obtained. Thus, a sensor output having undergone correction for H₂O concentration is obtained.

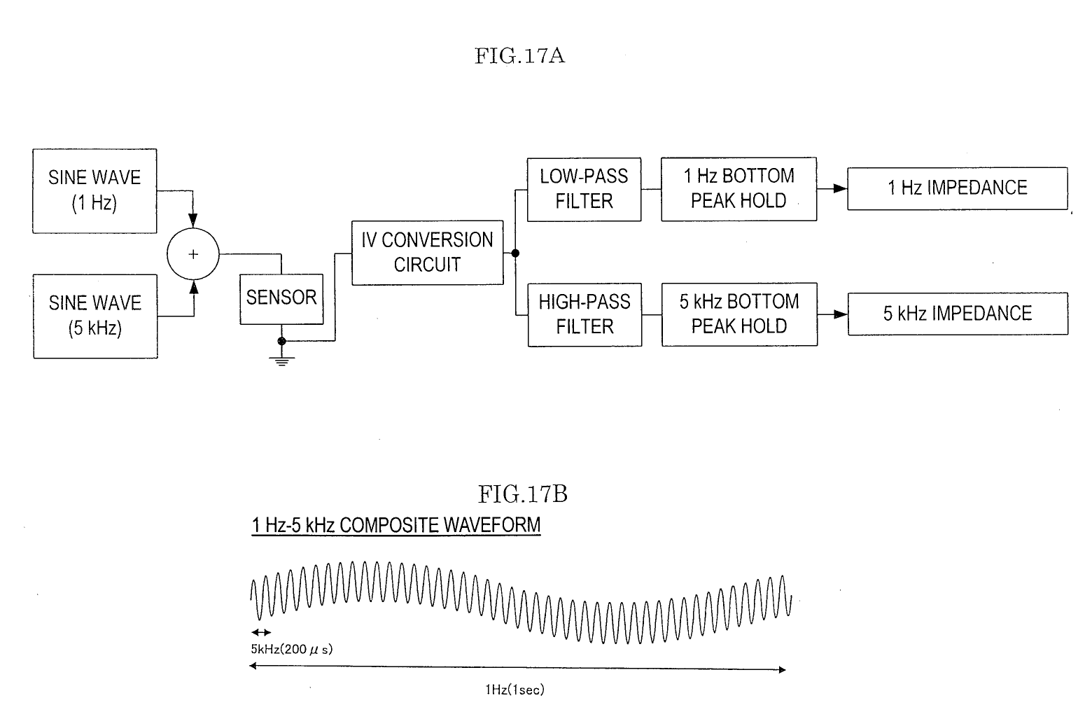

b) Alternatively, as shown in FIG. 17A, a composite wave composed of a low frequency (1 Hz) wave and a high frequency (5 kHz) wave; i.e., a composite voltage composed of a low frequency (1 Hz) AC component, and a high frequency (5 kHz) AC component superposed thereon (see FIG. 17B) is produced, and is applied to the sensor. The current value at the time when the composite voltage is applied to the sensor is converted to a voltage by means of an IV conversion circuit. The bottom peaks of low frequency voltage and high frequency voltage, which are separated from the voltage by means of a low-pass filer and a high-pass filter, respectively, are held, and the impedance at the low frequency and the impedance at the high frequency are calculated from these values.

A predetermined calculation is performed by use of the impedance at the low frequency and the impedance at the high frequency, whereby the above-mentioned impedance difference ΔZ is obtained. After that, a CO concentration corresponding to ΔZ is obtained. Thus, a sensor output having undergone correction for H₂O concentration is obtained.

### EXPERIMENTAL EXAMPLE 9

In Experimental Example 9, experiments were performed to determine the range of the above-described two frequencies, in which ranges correction for H₂O concentration can be performed in the gas sensor of Embodiment 2 shown in FIG. 2.

Specifically, under the conditions as described below, the impedance for the case where CO=100 ppm was obtained by use of the above-described impedance analyzer, while the measurement frequency was changed. Also, the difference between the impedance for the case where CO=100 ppm and the impedance for the case where CO=0 ppm was obtained as sensitivity.

<<Measurement Conditions>>

Gas component: CO=0, 100 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt carrying carbon catalyst (catalyst density: 1 mg/cm²)

Electrode catalyst of the second electrode: Pt carrying carbon catalyst (catalyst density: 0.015 mg/cm²)

<<Impedance Analyzer>>

The following is set between the first and second electrodes.

DC voltage: 700 mV

AC voltage: 150 mV (effective value)

Measurement frequency: 1000000 to 0.1 Hz

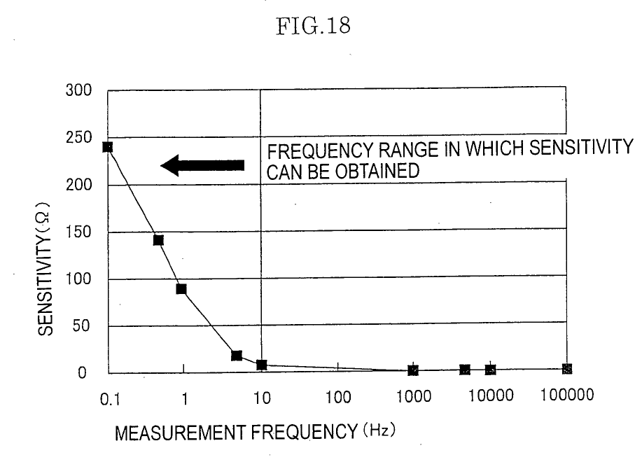

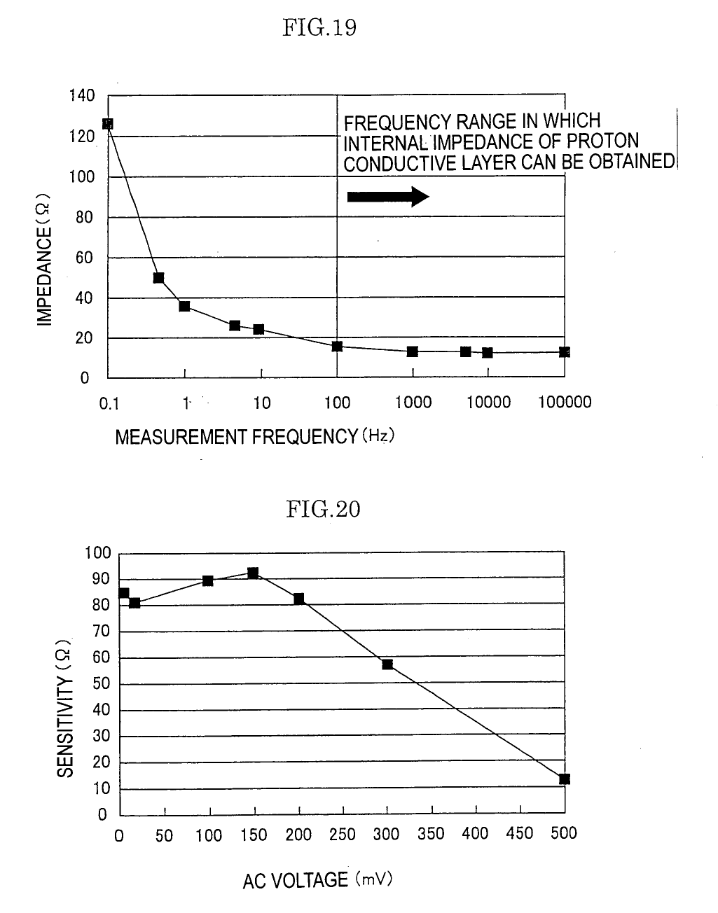

FIGS. 18 and 19 show graphs of the measurement results. In FIG. 18, the horizontal axis represents the measurement frequency, and the vertical axis represents the sensitivity at 100 ppm. In FIG. 19, the horizontal axis represents the measurement frequency, and the vertical axis represents the impedance at 100 ppm.

From FIG. 18, low-frequency side frequencies preferable for performance of H₂O concentration correction can be determined among different frequencies. That is, as is understood from FIG. 18, sensitivity is obtained in a range of 10 Hz or lower. Therefore, in the case of the gas sensor of Embodiment 2, the frequency suitable for measurement of CO concentration is 10 Hz or lower. Moreover, in consideration of the fact that when the frequency is excessively low, the sampling time becomes too long with a resultant deterioration in responsiveness, the low-frequency-side frequency is preferably set to 10 Hz to 0.05 Hz, more preferably set to 1 Hz.

Meanwhile, from FIG. 19, high-frequency side frequencies preferable for performance of correction for H₂O concentration can be determined among different frequencies. That is, as is understood from FIG. 19, the impedance does not change at frequencies equal to or higher than 100 Hz. Therefore, use of a frequency equal to or higher than 100 Hz enables measurement of the impedance of the proton conductive layer, and enables correction for H₂O concentration. The high-frequency-side frequency is preferably set to 100000 Hz to 100 Hz, more preferably set to 5 kHz.

### EXPERIMENTAL EXAMPLE 10

In Experimental Example 10, an experiment was performed to determine AC voltage for impedance measurement in the gas sensor of Embodiment 2 shown in FIG. 2.

Specifically, under the conditions as described below, the sensitivity when CO of 100 ppm was introduced (the difference between the impedance for the case where CO=100 ppm and the impedance for the case where CO=0 ppm) was measured, while the AC voltage was changed.

<<Measurement Conditions>>

Gas component: CO=0, 100 ppm

Remaining gas components: H₂=35%; CO₂=15%; H₂O=25%; and N₂ (balance) (volume %)

Gas temperature: 80° C.

Gas flow rate: 10 L/min

Electrode catalyst of the first electrode: Pt carrying carbon catalyst (catalyst density: 1 mg/cm²)

Electrode catalyst of the second electrode: Pt carrying carbon catalyst (catalyst density: 0.015 mg/cm²)

<<Impedance Analyzer>>

The following is set between the first and second electrodes.

DC voltage: 0 mV

AC voltage: 5, 10, 100, 150, 200, 300, 500 mV (effective value)

Measurement frequency: 1 Hz

FIG. 20 shows the results. As is apparent from FIG. 20, impedance measurement is possible when the AC voltage is 5 mV or higher. Since high sensitivity is preferred, the AC voltage is preferably set to 5 mV to 300 mV, and more preferably set to 150 mV, at which the sensitivity becomes highest.

### EXPERIMENTAL EXAMPLE 11

In Experimental Example 11, an experiment was performed to evaluate change in the sensitivity of the gas sensor of Embodiment 2 shown in FIG. 2 when the quantity of the catalyst of the second electrode was changed.

Specifically, under the conditions as described below, the difference between the 1 Hz impedance and the 5 kHz impedance was obtained by use of the above-described impedance analyzer.

<<Measurement Conditions>>

Gas component: CO=0, 10, 20, 50, 100, 200, 500, 1000, 2000, 10000, 20000 ppm

Remaining gas components: H₂=35%; CO₂=15%; H₂O=25% and N₂ (balance) (volume %)

Gas temperature: 80° C.

Gas flow rate: 10 L/min

Electrode catalyst of the first electrode: Pt carrying carbon catalyst (catalyst density: 1 mg/cm²)

Electrode catalyst of the second electrode: Pt carrying carbon catalyst (catalyst density: 1.5 μg/cm², 15 μg/cm², 150 μg/cm², 1 mg/cm²)

<<Impedance Analyzer>>

The following is set between the first and second electrodes.

DC voltage: 700 mV

AC voltage: 150 mV (effective value)

Measurement frequency: 1 Hz, 5 kHz

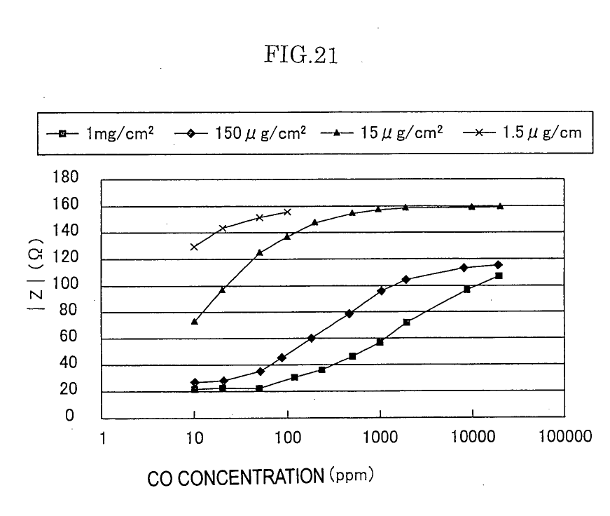

FIG. 21 shows the measurement results. As is apparent from FIG. 21, when the catalyst quantity is 1 mg/cm², the impedance hardly changes in the range of 10 to 100 ppm. However, when the catalyst quantity is reduced, the impedance changes for CO of low concentration of 10 to 100 ppm. That is, the sensor has sensitivity.

Moreover, it is understood from FIG. 21 that the concentration range in which the sensor has sensitivity changes depending on the catalyst quantity. From this result, it is understood that the measurable range for CO concentration can be changed by changing the catalyst quantity of the electrodes of the sensor.

Notably, the present invention is not limited to the above-described embodiments, and may be practiced in various forms without departing from the scope of the present invention.

For example, the electrode catalyst used for the first electrode, etc. are not limited to those described in the above-described embodiments and experimental examples, and any catalyst can be used so long as a selected catalyst can adsorb a catalyst poison gas contained in an analyte gas, and can generate hydrogen or protons through decomposition, dissociation, or reaction with a hydrogen-containing substance.

Although recovery means such as a heater is not necessarily required in the present invention, the recovery means such as a heater may be provided in order to further improve the performance.

### INDUSTRIAL APPLICABILITY

The gas sensor of the present invention is suitable for measurement, in a fuel cell, of concentration of a catalyst poison gas, such as CO, sulfur-containing substance, etc. which are contained in fuel gas, and in particular, concentration of CO. The present invention can provide a gas sensor which enables reversible, continuous measurement of concentration of a catalyst poison gas such as CO, without requiring recovery means such as a heater. Also, the present invention can provide a gas sensor which can measure concentration of a catalyst poison gas without being influenced by H₂O concentration. Moreover, the present invention can provide a gas sensor which has good responsiveness.

1. A gas sensor characterized by comprising a proton conductive layer which conducts protons; and first and second electrodes provided in contact with the proton conductive layer, each of the electrodes including electro-chemically active catalyst and being in contact with an atmosphere of an analyte gas, wherein
an AC voltage is applied between the first and second electrodes so as to measure an impedance between the first and second electrodes, and a concentration of a catalyst poison gas contained in the analyte gas is obtained on the basis of the impedance.

2. A gas sensor characterized by comprising a proton conductive layer which conducts protons; a first electrode provided in contact with the proton conductive layer, the first electrode including electro-chemically active catalyst and being shielded from an atmosphere of an analyte gas; and a second electrode provided in contact with the proton conductive layer, the second electrode including electro-chemically active catalyst and being in contact with the analyte-gas atmosphere, wherein
an AC voltage is applied between the first and second electrodes so as to measure an impedance between the first and second electrodes, and a concentration of a catalyst poison gas contained in the analyte gas is obtained on the basis of the impedance.

3. A gas sensor as described in claim 2, wherein the impedance between the first and second electrodes is measured in a state in which a DC voltage is applied between the first and second electrodes such that the first electrode is higher in electrical potential than the second electrode.

4. A gas sensor as described in claim 3, wherein the DC voltage is equal to or lower than 1200 mV.

5. A gas sensor characterized by comprising a proton conductive layer which conducts protons; a diffusion-rate determining portion for determining the rate of diffusion of an analyte gas; a measurement chamber communicating with an atmosphere of the analyte gas via the diffusion-rate determining portion; a first electrode accommodated in the measurement chamber, the first electrode being in contact with the proton conductive layer and including electro-chemically active catalyst; and a second electrode provided outside the measurement chamber, the second electrode being in contact with the proton conductive layer and including electro-chemically active catalyst, wherein
a DC voltage is applied between the first and second electrodes such that the first electrode is higher in electrical potential than the second electrode, to thereby pump hydrogen or protons, an AC voltage is applied between the first and second electrodes so as to measure an impedance between the first and second electrodes, and a concentration of a catalyst poison gas contained in the analyte gas is obtained on the basis of the impedance.

6. A gas sensor characterized by comprising a proton conductive layer which conducts protons; a diffusion-rate determining portion for determining the rate of diffusion of an analyte gas; a measurement chamber communicating with an atmosphere of the analyte gas via the diffusion-rate determining portion; a first electrode accommodated in the measurement chamber, the first electrode being in contact with the proton conductive layer and including electro-chemically active catalyst; and a second electrode and a reference electrode provided outside the measurement chamber, the second and reference electrodes being in contact with the proton conductive layer and including electro-chemically active catalyst, wherein
the gas sensor has a first operation step in which a DC voltage is applied between the first and second electrodes such that the first electrode is higher in electrical potential than the second electrode and such that a predetermined potential difference is produced between the first electrode and the reference electrode, and a second operation step in which a DC voltage is applied between the first and second electrodes so as to pump hydrogen or protons, and an AC voltage is applied between the first and second electrodes so as to measure an impedance between the first and second electrodes, wherein a concentration of a catalyst poison gas contained in the analyte gas is obtained on the basis of the impedance obtained in the second operation step.

7. A gas sensor as described in claim 6, wherein the second electrode serves as the reference electrode, and the second electrode and the reference electrode are integrated into a single member.

8. A gas sensor as described in claim 6, wherein the potential difference between the first electrode and the reference electrode is equal to or greater than a potential for oxidation of the catalyst poison gas.

9. A gas sensor as described in claim 8, wherein the potential difference between the first electrode and the reference electrode is equal to or higher than 250 mV.

10. A gas sensor as described in 5, wherein the AC voltage is applied between the first and second electrodes so as to measure the impedance in a state in which a DC voltage is applied between the first and second electrodes.

11. A gas sensor as described in claim 10, wherein the DC voltage applied between the first electrode and the second electrode is equal to or higher than a voltage for oxidation of the catalyst poison gas.

12. A gas sensor as described in claim 11, wherein the DC voltage applied between the first electrode and the second electrode is equal to or higher than 400 mV.

13. A gas sensor as described in claim 11, wherein the lower limit value of the AC voltage which is applied between the first electrode and the second electrode in a state in which the DC voltage is applied between the first electrode and the second electrode is equal to or higher than a voltage for oxidation of the catalyst poison gas.

14. A gas sensor as described in claim 13, wherein the lower limit value of the AC voltage is 400 mV or higher.

15. A gas sensor as described in claim 5, wherein a current which flows upon application of voltage between the first and second electrodes is a limiting current.

16. A gas sensor as described in claim 15, wherein a hydrogen concentration of the analyte gas is obtained from the limiting current.

17. A gas sensor as described in claim 5, wherein the catalyst contained in the first electrode is a catalyst capable of adsorbing the catalyst poison gas contained in the analyte gas and generating hydrogen or protons through decomposition, dissociation, or reaction with a hydrogen-containing substance.

18. A gas sensor as described in claim 1, wherein the concentration of the catalyst poison gas contained in the analyte gas is obtained on the basis of the impedance measured through application of AC voltages of different frequencies between the first and second electrodes.

19. A gas sensor as described in claim 18, wherein the impedance measured through application of AC voltages of different frequencies includes two impedances which are measured through application of an AC voltage having a switching waveform composed of alternating waveforms of two different frequencies.

20. A gas sensor as described in claim 18, wherein the impedance measured through application of an AC voltages of different frequencies includes two impedances which are measured through application of AC voltage having a composite waveform composed of waveforms of two different frequencies.

21. A gas sensor as described in claim 19, wherein one of the two different frequencies falls within a range of 10000 Hz to 100 Hz, and the other frequency falls within a range of 10 Hz to 0.05 Hz.

22. A gas sensor as described in claim 1, wherein the AC voltage applied between the first and second electrodes is 5 mV or higher.

23. A gas sensor as described in claim 1, wherein the catalyst used for the second electrode is a catalyst capable of adsorbing the catalyst poison gas contained in the analyte gas.

24. A gas sensor as described in claim 1, wherein the density of the catalyst used for the electrodes falls within a range of 0.1 μgg/cm² to 10 mg/cm².

25. A gas sensor as described in claim 1, wherein the catalyst poison gas is CO or a sulfur-containing substance.
